(19) United States
(12) Patent Application Publication
(10) Pub. No.: US 2007/0261601 A1
(43) Pub. Date: Nov. 15, 2007

(54) Hardening Composition, Antireflective Film, Method of Producing the Same, Polarizing Plate and Image Display Unit

(75) Inventors: Akira Ikeda, Minami-Ashigara-shi (JP); Takumi Ando, Minami-Ashigara-shi (JP); Hiroyuki Yoneyama, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FujiFilm Corporation, Tokyo (JP)

(21) Appl. No.: 11/660,954

(22) PCT Filed: Sep. 21, 2005
(86) PCT No.: PCT/JP05/17910

§ 371 Date: Feb. 23, 2007

(30) Foreign Application Priority Data
Sep. 22, 2004 (JP) 2004-275415

(51) Int. Cl. C08L 101/00; C08K 7/26; G02B 1/11; G02F 1/1335; G09F 9/00; G02B 5/30; C08K 9/06

(52) U.S. Cl. 106/287.12; 106/287.34; 427/299

(57) ABSTRACT

A hardening composition comprising: a binder comprising at least one of a hardening monomer and a polymer; hollow silica fine particles; and inorganic fine particles, wherein the inorganic fine particles has an average particle diameter larger than an average particle diameter of the hollow silica fine particles.; an antireflective film having an optically functional layer made of the above hardening composition; a polarizing plate having the above antireflective film; and a liquid crystal display unit or an organic EL display unit having the above antireflective film or the above polarizing plate.

### TECHNICAL FIELD

This invention relates to a hardening (curable) composition, an antireflective film and a polarizing plate and an image display unit using the same. In particular, it relates to an antireflective film containing hollow silica fine particles and inorganic fine particles different therefrom and a polarizing plate and an image display unit using the same. The invention further relates to a method of producing an antireflective film.

### BACKGROUND ART

Low-reflective coatings and antireflective films to be used on the surface of displays and monitors should be less reflective. Moreover, it is required that they are highly durable so as to withstand various environments when employed as protective coatings or protective films. It is known that hollow silica fine particles disclosed in JP-A-2001-233611 have a low refractive index owing to the hollow inside compared with commonly employed silica fine particles. JP-A-2002-317152, JP-A-2003-202406 and JP-A-2003-292831 disclose coating agents having low refractive index and antireflection films containing the above-described hollow silica fine particles. JP-A-2004-94007 discloses an antireflective film containing the above-described hollow silica fine particles in an antistatic layer. These disclosures relate respectively to techniques of controlling refractive index with the use of the low refractive index of the hollow silica fine particles.

### DISCLOSURE OF THE INVENTION

The inventors noticed that the techniques disclosed by the above Documents suffer from a serious problem of insufficient mechanical strength (i.e., so-called scratch resistance). Thus, they have conducted intensive studies for overcoming this problem and, as a result, found out that membrane strength characteristics, which are important as well as optical characteristics, can be largely improved according to the invention.

The first object of the invention is to provide a hardening composition capable of forming a membrane which has both of a low refractive index and a high strength. The second object of the invention is to provide an antireflective film which is less reflective and excellent in scratch resistance.

Another object of the invention is to provide a polarizing plate and an image display unit such as a liquid crystal display unit with the use of such an excellent antireflective film.

According to the invention, a hardening composition having the following constitution, an antireflective film, a method of producing the same, a polarizing plate and an image display unit are provided, thereby establishing the above-described objects.

(1) A hardening composition comprising:

a binder comprising at least one of a hardening monomer and a polymer;

hollow silica fine particles; and

inorganic fine particles,

wherein the inorganic fine particles has an average particle diameter larger than an average particle diameter of the hollow silica fine particles.

(2) The hardening composition as described in (1) above, which further comprises at least one of a hydrolysate of an organosilane represented by formula (A) and a partial condensation product of an organosilane represented by formula (A):
(R¹⁰)ₘSi(X)₄₋ₘ formula (A):

wherein R¹⁰ represents a substituted or unsubstituted alkyl group or a substituted or unsubstituted aryl group;

X represents a hydroxyl group or a hydrolyzable group; and

m is an integer of from 1 to 3.

(3) The hardening composition as described in (1) or (2) above,

wherein at least one of the inorganic fine particles and the hollow silica fine particles is surface-treated with an organosilane compound represented by formula (A).

(4) The antireflective film comprising an optically functional layer formed from a hardening composition as described in any of (1) to (3) above.

(5) The antireflective film as described in (4) above,

wherein an average particle diameter of the inorganic fine particles having an average particle diameter larger than an average particle diameter of the hollow silica fine particles is not more than 120% based on an average layer thickness of the optically functional layer.

(6) A method of producing an antireflective film as described in (4) or (5) above, the method comprising:

forming an optically functional layer by applying a hardening composition by a die coating method.

(7) A polarizing plate comprising an antireflective film as described in (4) or (5) above.

(8) An image display unit comprising an antireflective film as described in (4) or (5) above or a polarizing plate as described in (7) above.

### BEST MODE FOR CARRYING OUT THE INVENTION

The hardening (curable) composition according to the invention is characterized by containing, in a binder polymer comprising at least one of a hardening (curable) monomer and a polymer, hollow silica fine particles and inorganic fine particles having an average particle diameter larger than the average particle diameter of the silica fine particles. The hardening composition of the invention in which the type of the inorganic fine particles is varied depending on the intended optical function may form various types of optically functional layers, i.e., low refractive index layer, middle refractive index layer, high refractive index layer, hard coat layer, antistatic layer, therefore giving an antireflective film. The average particle diameter of the inorganic fine particles may be determined on electromicroscopic photographs of the particles, and it is a number-average particle diameter of the fine particles as spheres.

Next, materials of the hardening composition according to the invention, a method of constructing an antireflective film from the composition, etc. will be illustrated. The expression “from (numerical value 1) to (numerical value 2)” as used herein in numerically indicating characteristics, physical properties or the like means “at least (numerical value 1) but not more than (numerical value 2)”. The term “(meth)acryloyl” as used herein means “at least one of acryloyl and methacryloyl” and the same applies to “(meth)acrylate”, “(meth)acrylic acid” and so on.

[Hollow Silica Particle]

Next, the hollow silica particles to be used in the hardening composition according to the invention will be illustrated.

The refractive index of the hollow silica fine particles preferably ranges from 1.17 to 1.40, still preferably from 1.17 to 1.35 and most desirably from 1.17 to 1.30. The refractive index as used herein means not the refractive index of the silica, i.e., the shell forming the hollow particles, but the refractive index of the particles as a whole. When the radius of the inner cavity in a particle is referred to as a and the radius of the outer shell of the particle is referred to as b, the porosity x, which is represented by the following numerical formula (VIII), preferably ranges from 10 to 60%, still preferably from 20 to 60% and most desirably form 30 to 60%.
x=(4πa³/3)/(4πb³/3)×100 Numerical formula (VIII):

In the case of attempting to achieve a lower refractive index of the hollow silica particles and a higher porosity thereof, the thickness of the shell is reduced and the strength of the particles is worsened. From the viewpoint of the scratch resistance, therefore, any particle having a refractive index less than 1.17 is unavailable.

The refractive index of these hollow silica particles is measured with an Abbe refractometer (manufactured by ATAGO).

Methods of producing hollow silica particles are described in, for example, JP-A-2001-233611 and JP-A-2002-79616.

The coating amount of the hollow silica particles is preferably from 1 mg/m² to 100 mg/m², still preferably from 5 mg/m² to 80 mg/m² and still preferably from 10 mg/m² to 60 mg/m².

So long as the coating amount of the hollow silica particles falls within the range as described above, the effects of achieving a low refractive index and improving scratch resistance can be established without causing troubles, for example, worsening in appearance such as definitiveness in black color and lowering integral reflection ratio due to the formation of fine peaks and valleys on the surface of the low refractive index layer.

The average particle diameter of the hollow silica particles preferably amounts to from 30% to 150% of the thickness of the low refractive index layer, still preferably from 35% to 80% and still preferably form 40% to 60%. In the case where the low refractive index layer has a thickness of 100 nm, namely, the average particle diameter of the hollow silica particles preferably ranges from 30 nm to 150 nm, still preferably from 35 nm to 80 nm and still preferably from 40 nm to 60 nm.

So long the hollow silica fine particle fall within the range as described above, the ratio of the cavity can be elevated and a low refractive index can be achieved. Moreover, there arises no trouble, for example, worsening in appearance such as definitiveness in black color and lowering integral reflection ratio due to the formation of fine peaks and valleys on the surface of the low refractive index layer.

The silica fine particles may be either crystalline particles or amorphous ones and singly dispersed particles are favorable. Concerning the shape, spherical particles are most desirable but those having an undefined shape may be also usable without any problem.

The average particle diameter of the hollow silica fine particles is measured by using an electron microscopic photograph too.

[Inorganic Fine Particle]

Next, the inorganic fine particles having an average particle diameter larger than the average particle diameter of the silica fine particles, which are to be used in the invention together with the hollow silica particles, will be illustrated. The average particle diameter of the inorganic fine particles preferably from 40 nm to 100 nm, still preferably from 45 nm to 80 mm and most desirably from 45 nm to 65 nm. An embodiment where the inorganic fine particles having a larger average particle diameter than that of the hollow silica fine particles as referred to herein are hollow fine particles is also one preferred embodiment of the invention.

The ratio of the average particle diameter (R1 nm) of the hollow silica particles to the average particle diameter of the large-sized inorganic fine particles (R2 nm), i.e., R1/R2 is preferably from 0.3 to 1.0, still preferably from 0.5 to 0.9 and particularly preferably from 0.6 to 0.8.

It is preferable that the average particle size (diameter) of an inorganic fine particle having the largest particle diameter is not more than 120% of the thickness of the layer formed of the hardening composition of the invention that contains hollow silica fine particles and inorganic fine particles having a larger average particle diameter than that of the hollow silica fine particles in a binder, more preferably not more than 100%, even more preferably from 30% to 80%.

The hollow silica fine particles and the inorganic fine particles to be used in the invention may be subjected to a physical surface treatment such as plasma discharge treatment or corona discharge treatment or a chemical surface treatment with the use of, for example, a surfactant or a coupling agent (for example, an organosilane compound as will be illustrated hereinafter) to thereby stabilize the dispersion thereof in a liquid dispersion or a coating solution or to improve the affinity and binding properties thereof to a binder component. It is particularly preferable to employ a coupling agent therefor. As the coupling agent, it is preferable to use an alkoxymetal compound (for example, a titanium coupling agent or a silane coupling agent as will be illustrated hereinafter). Among all, a treatment with a silane coupling agent having an acryloyl group or a methacryloyl group is particularly effective.

The coupling agent is employed as a surface-treating agent by which the inorganic filler in the low refractive index layer is preliminarily surface-treated before the preparation of the coating solution for forming the layer. It is preferable that the coupling agent is further added as an additive in preparing the coating solution for forming the layer so that the low refractive index layer contains the coupling agent. The additive may be either a silane coupling agent (an organosilane compound) as will be illustrated hereinafter or a hydrolysate thereof or its partial condensation product and the latter is preferred.

To lessen the load during the surface-treatment, it is preferable that the fine particles are preliminarily dispersed in a medium before the surface-treatment.

The inorganic fine particles to be used in the invention are not particularly restricted in shape. For example, use can be preferably made of spherical, plate-like, fibrous, rod-like, irregular-shaped or hollow particles, though spherical ones are preferred because of having favorable dispersibility. Also, the inorganic fine particles is not restricted in type, though it is preferable to use an amorphous ones. It is preferable that the inorganic fine particles comprise an oxide, nitride, sulfide or halide of a metal and a metal oxide is still preferred.

Examples of the metal atom in the metal oxide include Na, K, Mg, Ca, Ba, Al, Zn, Fe, Cu, Ti, Sn, In, W, Y, Sb, Mn, Ga, V, Nb, Ta, Ag, Si, B, Bi, Mo, Ce, Cd, Be, Pb, Ni and so on. In the invention, means of using the inorganic filler is not particularly restricted. For example, it may be used in a dry state or as a dispersion in water or an organic solvent. In the invention, it is also preferable to use a dispersion stabilizer so as to prevent the inorganic fine particles from aggregation and sedimentation. As the dispersion stabilizer, use can be made of polyvinyl alcohol, polyvinylpyrrolidone, cellulose derivatives, polyamides, phosphoric acid esters, polyethers, surfactants, silane coupling agents and titanium coupling agents. A silane coupling agent is particularly preferred since a strong coating membrane can be obtained after hardening (curing) by using the same. It is preferable that the inorganic fine particles according to the invention are contained in the hardening composition in an amount of from 35% by mass to 65% by mass, based on the total solid components, still preferably from 45% by mass to 60% by mass. (In this specification, % by mass and parts by mass are equal to % by weight and parts by weight, respectively.)

Next, the hydrolysate of an organosilane compound or its partial condensation product, i.e., a so-called sol component (the same will be employed hereinafter too) will be illustrated in detail.

The organosilane compound is represented by the following general formula (A):
(R¹⁰)ₘSi(X)₄₋ₘ General formula (A):

In the general formula (A), R¹⁰ represents a substituted or unsubstituted alkyl group or a substituted or unsubstituted aryl group. Examples of the alkyl group include methyl, ethyl, propyl, isopropyl, hexyl, t-butyl, sec-butyl, hexyl, decyl, hexadecyl and so on. A preferable alkyl group is one having from 1 to 30 carbon atoms, still preferably from 1 to 16 carbon atoms and particularly preferably from 1 to 6 carbon atoms. Examples of the aryl group include phenyl, naphthyl and so on and a phenyl group is preferable.

X represents a hydroxyl group or a hydrolyzable group. Examples of the hydrolyzable group include alkoxy groups (preferably alkoxy groups having from 1 to 5 carbon atoms such as methoxy and ethoxy groups), halogen atoms (for example, CL, Br, I and so on) and R²COO (wherein R² preferably represents a hydrogen atom or an alkyl group having from 1 to 5 carbon atoms such as CH₃COO or C₂H₅COO). Alkoxy groups are preferable and a methoxy or ethoxy group is still preferable. m is an integer or from 1 to 3. In the case where a plurality of R¹⁰ s or Xs are present, these R¹⁰s or Xs may be either the same or different. m is preferably 1 or 2, still preferably 1.

Although the substituent in R¹⁰ is not particularly restricted, preferable examples of the substituent include halogen atoms (for example, fluorine, chlorine and bromine atoms), hydroxyl group, mercapto group, carboxyl group, epoxy group, alkyl groups (for example, methyl, ethyl, i-propyl, propyl and t-butyl groups), aryl groups (for example, phenyl and naphthyl groups), aromatic heterocyclic groups (for example, furyl, pyrazolyl and pyridyl groups), alkoxy groups (for example, methoxy, ethoxy, i-propoxy and hexyloxy groups), aryloxy groups (for example, phenoxy group), alkylthio groups (for example, methylthio and ethylthio groups), arylthio groups (for example, phenylthio group), alkenyl groups (for example, vinyl and 1-propenyl groups), acyloxy groups (for example, acetoxy, acryloyloxy and methacryloyloxy groups), alkoxycarbonyl groups (for example, methoxycarbonyl and ethoxycarbonyl groups), aryloxycarbonyl groups (for example, phenoxycarbonyl group), carbamoyl groups (for example, carbamoyl, N-methylcarbamoyl, N,N-dimethylcarbamoyl and N-methyl-N-octylcarbamoyl group), and acylamino groups (for example, acetylamino, benzoylamino, acrylamino and methacrylamino groups). Such a substituent may be further substituted. In the case where a plurality of R¹⁰s are present, it is preferable that at least one of these R¹⁰s is a substituted alkyl group or a substituted aryl group. Among all, an organosilane compound having a vinyl-polymerizable substituent represented by the general formula (B) is preferred.

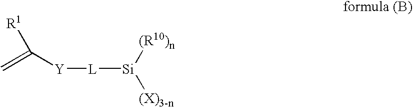

In the general formula (B), R¹ represents a hydrogen atom, a methyl group, a methoxy group, an alkoxycarbonyl group, a cyano group, a fluorine atom or a chlorine atom. Examples of the alkoxycarbonyl group include methoxycarbonyl group, ethoxycarbonyl group and so on. Among all, a hydrogen atom, a methyl group, a methoxy group, a methoxycarbonyl group, a cyano group, a fluorine atom or a chlorine atom is preferred, a hydrogen atom, a methyl group, a methoxy group, a methoxycarbonyl group, a fluorine atom or a chlorine atom is still preferred, and a hydrogen atom or a methyl group is particularly preferred. Y represents a single bond, an ester group, an amido group, an ether group or a urea group. Among all, a single bond, an ester group or an amido group is preferred, a single bond or an ester group is still preferred and an ester group is particularly preferred.

L represents a divalent linking group. Specific examples thereof include substituted or unsubstituted alkylene groups, substituted or unsubstituted arylene groups, substituted or unsubstituted alkylene groups having a liking group (for example, ether, ester or amide) within molecule, and substituted or unsubstituted arylene groups having a liking group within molecule. Preferable examples thereof include substituted or unsubstituted alkylene groups having from 2 to 10 carbon atoms, substituted or unsubstituted arylene groups having from 6 to 20 carbon atoms and alkylene groups containing linking group therein and having from 3 to 10 carbon atoms; still preferably unsubstituted alkylene groups, unsubstituted arylene groups, and alkylene groups having ether or ester linking group within molecule; and particularly preferably unsubstituted alkylene groups and alkylene groups having ether or ester linking group within molecule. Examples of the substituent include halogens, hydroxyl group, mercapto group, carboxyl group, epoxy group, alkyl groups, aryl groups and so on. Such a substituent may be further substituted.

n is 0 or 1. A plurality of Xs may be either the same or different. n is preferably 0. R¹⁰ is as defined in the general formula (A). It preferably represents a substituted or unsubstituted alkyl group, or a unsubstituted aryl group, still preferably an unsubstituted alkyl group or an unsubstituted aryl group. X is as defined in the general formula (A). It preferably represents a halogen atom, a hydroxyl group or an unsubstituted alkoxy group, still preferably a chlorine atom, a hydroxyl group or an unsubstituted alkoxy group having form 1 to 6 carbon atoms, still preferably a hydroxyl group or an alkoxy group having from 1 to 3 carbon atoms, and particularly preferably a methoxy group.

Use can be also made of two or more types of the compounds represented by the general formula (A) or the general formula (B). Next, specific examples of the compounds represented by the general formula (A) or the general formula (B) will be presented, though the invention is not restricted thereto.

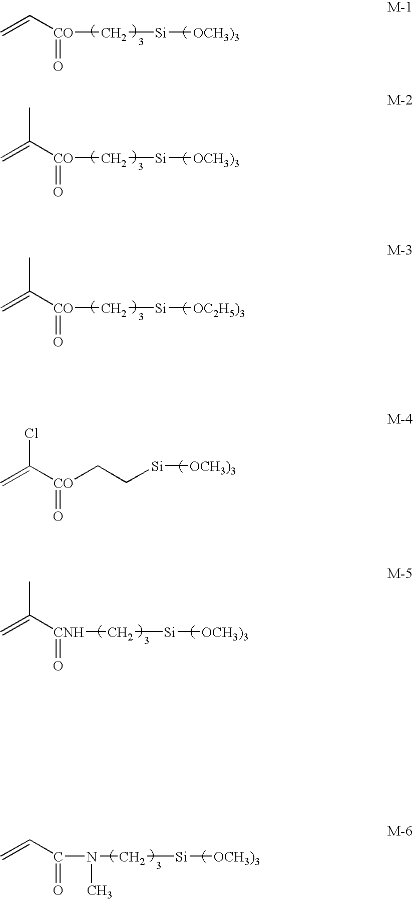

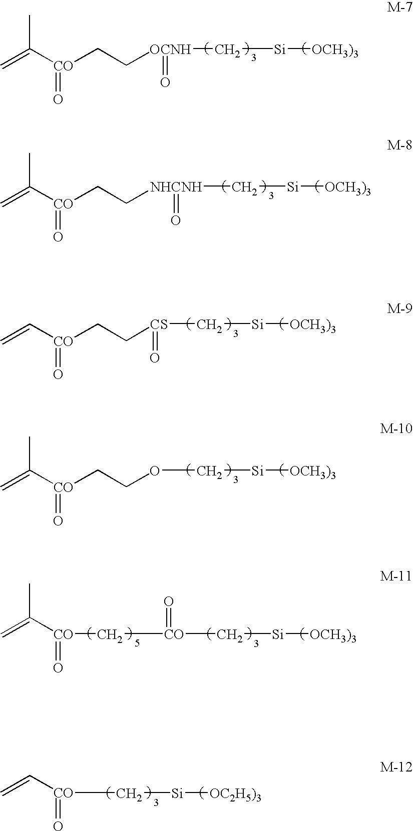

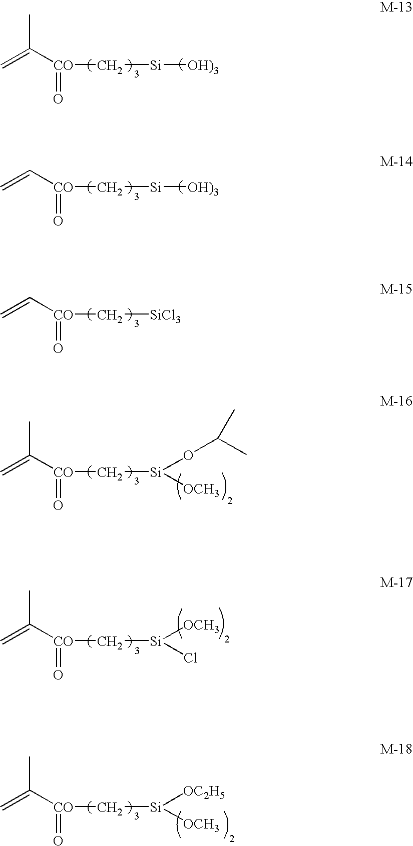

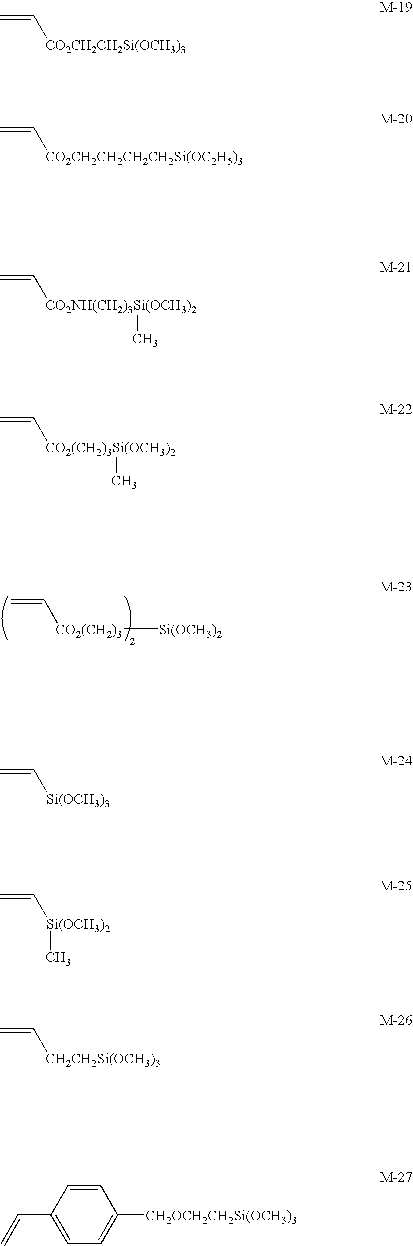

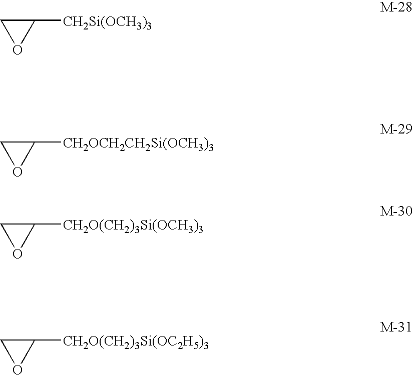

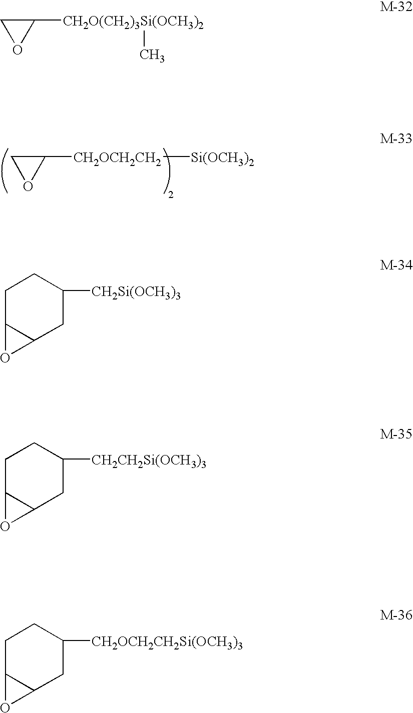

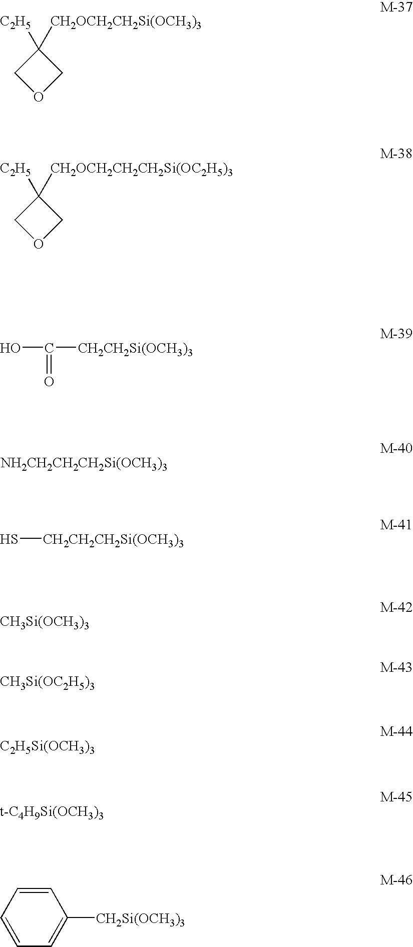

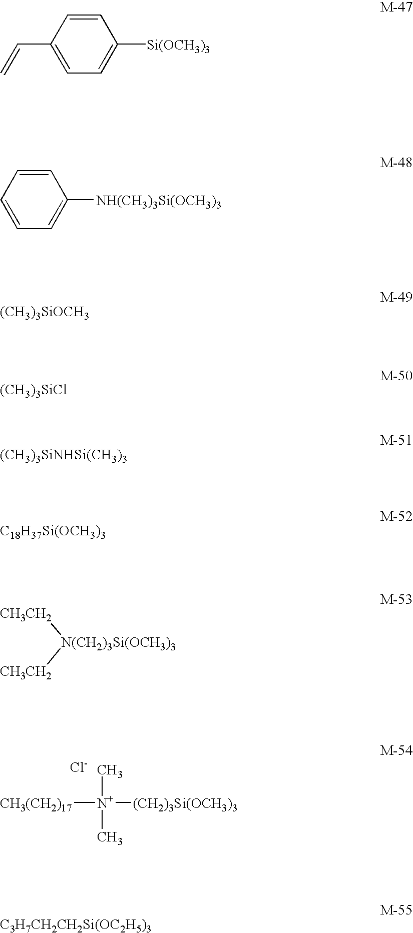

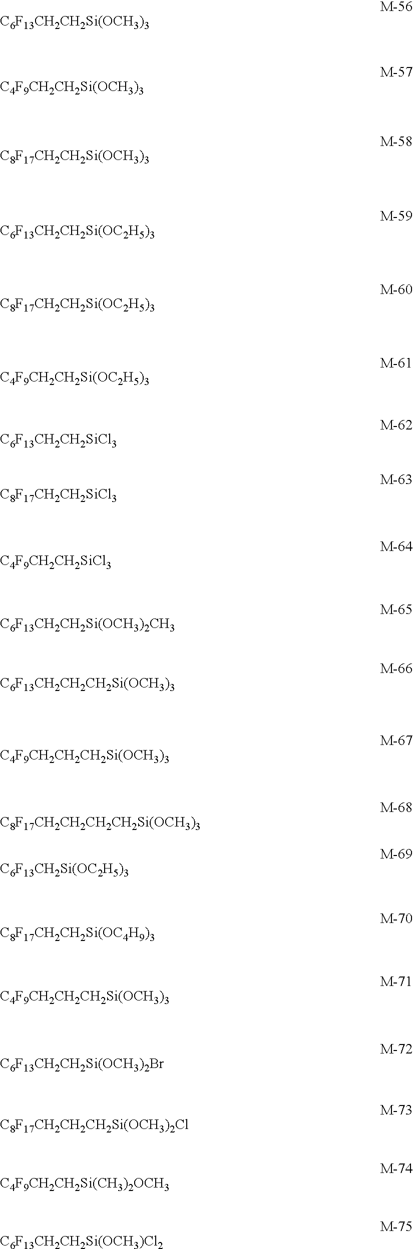

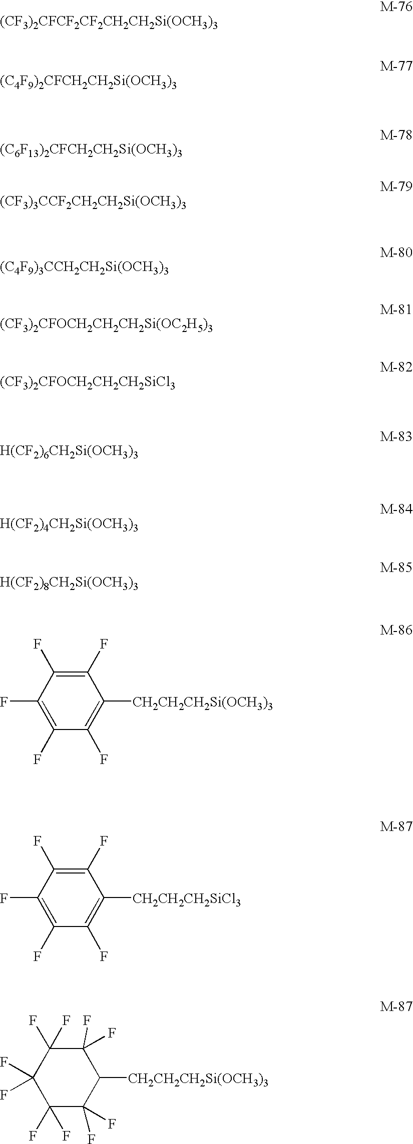

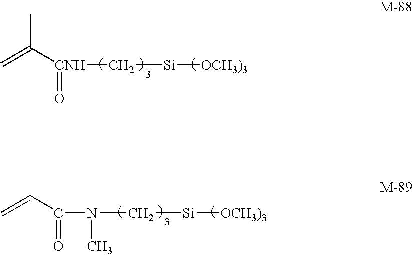

Among these specific examples, (M-1), (M-2), (M-30), (M-35), (M-49), (M-56), (M-57), etc. are particularly preferred.

Although the amount of the organosilane compound represented by the general formula (A) is not particularly restricted in the invention, it is preferably employed in an amount of from 1% by mass to 300% by mass, still preferably from 3% by mass to 100% by mass and most desirably from 5% by mass to 50% by mass, based on the inorganic oxide fine particles. Per hydroxyl group on the inorganic oxide surface, it is also preferable to employ the organosilane compound in an amount of from 1 to 300% by mol, still preferably from 5 to 300% by mol and most desirably from 10 to 200% by mol. So long as the content of the organosilane compound falls within the range as defined above, a sufficient effect of stabilizing the dispersion can be established and a satisfactory membrane strength can be obtained in forming a coating membrane.

In the invention, the surface of inorganic oxide fine particles is treated with the above-described organosilane compound to thereby improve the dispersibility of the inorganic oxide fine particles. More specifically speaking, a component originating in the organosilane compound is bonded to the surface of the inorganic oxide fine particles due to the hydrolysis/condensation reaction of the organosilane compound. The hydrolysis/condensation reaction of the organosilane compound is performed usually by adding from 0 to 2.0 mols of water, per mol of the hydrolyzable group (X), and stirring at 15 to 100° C. in the presence of an acid catalyst or a metal chelate compound usable in the invention.

(Acid Catalyst and Metal Chelate Compound)

It is preferable to prepare the sol component, i.e., the hydrolysate of an organosilane or its partial condensation product or a mixture thereof in the presence of a catalyst. As the catalyst, citation may be made of inorganic acids such as hydrochloric acid, sulfuric acid and nitric acid; organic acids such as oxalic acid, acetic acid, formic acid, methanesulfonic acid and toluenesulfonic acid; inorganic bases such as sodium hydroxide, potassium hydroxide and ammonia; organic bases such as triethylamine and pyridine; and metal alkoxides such as triisopropoxyaluminum and tetrabutoxyzirconium. From the viewpoints of the production stability of the inorganic oxide fine particle solution and the storage stability thereof, it is preferable in the invention to use at least one of acid catalysts (inorganic acids, organic acids) and metal chelate compounds. In inorganic acids, hydrochloric acid and sulfuric acid are preferred. In organic acids, those having an acid dissociation constant (pKa (25° C.)) in water of 4.5 or less are preferred. Hydrochloric acid, sulfuric acid and organic acids having an acid dissociation constant in water of 3.0 or less are still preferable; hydrochloric acid, sulfuric acid and organic acids having an acid dissociation constant in water of 2.5 or less are still preferable; organic acids having an acid dissociation constant in water of 2.5 or less are still preferable; methanesulfonic acid, oxalic acid, phthalic acid and malonic acid are still preferable; and oxalic acid is particularly preferable.

In the case where the hydrolyzable group of the organosilane is an alkoxy group and the acid catalyst is an organic acid, proton is supplied from carboxyl group or sulfo group in the organic acid. Thus, the amount of the water to be added can be decreased. Namely, water is added in an amount of from 0 to 2 mol, preferably from 0 to 1.5 mol, still preferably from 0 to I mol and particularly preferably from 0 to 0.5 mol per mol of the alkoxide group in the organosilane. When an alcohol is employed as the solvent, it is also appropriate to substantially add no water.

In the case where the acid catalyst is an inorganic acid, the acid catalyst is used in an amount of form 0.01 to 10% by mol, preferably from 0.1 to 5% by mol based on the hydrolyzable group. In the case where the acid catalyst is an organic acid, the appropriate amount of the catalyst varies depending on the amount of added water. When water is added, the acid catalyst is used in an amount of from 0.01 to 10% by mol, preferably from 0.1 to 5% by mol based on the hydrolyzable group. When water is substantially not added, the acid catalyst is used in an amount of from 1 to 500% by mol, preferably from 10 to 200% by mol, still preferably from 20 to 200% by moll, still preferably from 50 to 150% by mol and particularly preferably from 50 to 120% by mol, based on the hydrolyzable group.

The treatment is carried out by stirring at 15 to 100° C., though it is favorable to control the treating conditions depending on the reactivity of the organosilane.

Metal chelate compounds are appropriately selected, without specific restriction, from among those having an alcohol represented by the general formula R³OH (wherein R³ represents an alkyl group having from 1 to 10 carbon atoms) and/or a compound represented by the general formula R⁴COCH₂COR⁵ (wherein R⁴ represents an alkyl group having from 1 to 10 carbon atoms; and R⁵ represents an alkyl group having from 1 to 10 carbon atoms or an alkoxy group having from 1 to 10 carbon atoms) as a ligand and Zr, Ti and Al as the center metal. Two or more metal chelate compounds may be used together within the above scope. It is preferable to select the metal chelate compound to be used in the invention from the compounds represented by the following general formulae, thereby exerting an effect of accelerating the condensation reaction of the organosilane compound as described above:
Zr(OR³)ₚ₁(R⁴COCHCOR⁵)ₚ₂,
Ti(OR³)_{q1}(COCHCOR⁵)_{q2} and
Al(OR³)ᵣ₁(R⁴COCHCOR⁵)ᵣ₂.

In the above metal chelate compounds, R³ and R⁴ may be either the same or different and each represents an alkyl group having from 1 to 10 carbon atoms, more specifically speaking, an ethyl group, an n-propyl group, an i-propyl group, an n-butyl group, a sec-butyl group, a t-butyl group, an n-pentyl group, a phenyl group, etc. R⁵ represents the same alkyl group having from 1 to 10 carbon atoms as described above or an alkoxy group having form 1 to 10 carbon atoms such as a methoxy group, an ethoxy group, an n-propoxy group, an i-propoxy group, an n-butoxy group, a sec-butoxy group, a t-butoxy group, etc. In these metal chelate compounds, p1, p2, q1. q2, r1 and r2 represent each an integer which is determined so as to give a tetradentate or sexidentate coordination.

Specific examples of these metal chelate compounds include zirconium chelate compounds such as tri-n-butoxyethylacetoacetate zirconium, di-n-butoxybis(ethylacetoacetate) zirconium, n-butoxytris(ethylacetoacetate) zirconium, tetrakis(n-propylacetoacetate) zirconium, tetrakis(acetylacetoacetate) zirconium and tetrakis(ethylacetoacetate) zirconium; titanium chelate compounds such as diisopropoxy bis(ethylacetoacetate) titanium, diisopropoxy bis(acetylacetate) titanium and diisopropoxy bis(acetylacetone) titanium; and aluminum chelate compounds such as diisopropoxyethylacetoacetate aluminum, diisopropoxyacetylacetonate aluminum, isopropoxybis(ethylacetoacetate) aluminum, isopropoxybis(acetylacetonate) aluminum, tris(ethylacetoacetate) aluminum, tris(acetylacetonate) aluminum, and monoacetylacetonate bis(ethylacetoacetate) aluminum.

Among these metal chelate compounds, tri-n-butoxyethylacetoacetate zirconium, diisopropoxy bis(acetylacetonate) titanium, diisopropyloxyethylacetoacetate aluminum and tris(ethylacetoacetate) aluminum are preferable. One of these metal chelate compounds may be used alone. Alternatively, a mixture of two or more thereof may be used. Also, use can be made of a partly hydrolyzed product of such a metal chelate compound.

From the viewpoints of the condensation reaction speed and the membrane strength after forming a coating membrane, the metal chelate compound according to the invention is employed preferably in an amount of from 0.01 to 50% by mass, still preferably from 0.1 to 50% by mass and still preferably from 0.5 to 10% by mass based on the organosilane compound.

(Solvent in Treatment for Improving Dispersibility)

The treatment for improving the dispersibility with the use of at least a component selected from the hydrolysate of the organosilane compound and its partial condensation product can be carried out either in the absence of any solvent or in a solvent. In the case of using a solvent, the concentration of the hydrolysate of the organosilane compound or its partial condensation product can be appropriately determined. As the solvent, it is preferable to employ an organic solvent so as to homogeneously mix the components. For example, use may be appropriately made of alcohols, aromatic hydrocarbons, ethers, ketones and esters.

It is preferable to use a solvent in which the hydrolysate of the organosilane compound or its partial condensation product and a catalyst are soluble. From the viewpoint of production procedure, it is favorable that the organic solvent is employed as a coating solution or a portion of the coating solution. Thus, it is favorable to employ a solvent which would not worsen the solubility or dispersibility when mixed with other materials such as a fluorine-containing polymer.

As examples of the alcohols, monohydric alcohols and dihydric alcohols may be cited. As monohydric alcohols, saturated aliphatic alcohols having from 1 to 8 carbon atoms are preferable. Specific examples of such alcohols include methanol, ethanol, n-propyl alcohol, i-propyl alcohol, n-butyl alcohol, sec-butyl alcohol, tert-butyl alcohol, ethylene glycol, diethylene glycol, triethylene glycol, ethylene glycol monobutyl ether and ethylene glycol acetate monoethyl ether.

Specific examples of the aromatic hydrocarbons include benzene, toluene and xylene. Specific examples of the ethers include tetrahydrofuran and dioxane. Specific examples of the ketones include acetone, methyl ethyl ketone, methyl isobutyl ketone and diisobutyl ketone. Specific examples of the esters include methyl acetate, propyl acetate, butyl acetate and propylene carbonate.

Either one of these organic solvent or a mixture of two or more thereof may be used.

Although the concentration of the organosilane compound in this treatment for improving dispersibility is not particularly restricted, it usually ranges from 0.1% by mass to 70% by mass, preferably from 1% by mass to 50% by mass.

It is preferable in the invention that the inorganic fine particles are first dispersed in an alcoholic solvent and then treated so as to improve the dispersibility followed by the replacement of the dispersion solvent by an aromatic hydrocarbon solvent or a ketone solvent. From the viewpoints of the compatibility with the binder to be used together in the coating step and improvement in the stability of the dispersion per se, replacement by a ketone solvent is favorable.

(Catalyst for Dispersibility-Improving Treatment)

The treatment for improving the dispersibility of at least one of a hydrolysate of the organosilane compound and its partial condensation product is preferably carried out in the presence of a catalyst. As the catalyst, use can be preferably made of those described above concerning the acid catalyst and the metal chelate compound.

In the case where the hydrolyzable group of the organosilane compound is an alkoxy group and the acid catalyst is an organic acid, proton is supplied from carboxyl group or sulfo group in the organic acid. Thus, the amount of the water to be added can be decreased. Namely, water is added in an amount of from 0 to 2 mol, preferably from 0 to 1.5 mol, still preferably from 0 to 1 mol and particularly preferably from 0 to 0.5 mol per mol of the alkoxide group in the organosilane. When an alcohol is employed as the solvent, it is also appropriate to substantially add no water.

In the case where the acid catalyst is an inorganic acid, the acid catalyst is used in an amount of form 0.01 to 10% by mol, preferably from 0.1 to 5% by mol based on the hydrolyzable group. In the case where the acid catalyst is an organic acid, the appropriate amount of the catalyst varies depending on the amount of added water. When water is added, the acid catalyst is used in an amount of from 0.01 to 10% by mol, preferably from 0.1 to 5% by mol based on the hydrolyzable group. When water is substantially not added, the acid catalyst is used in an amount of from 1 to 500% by mol, preferably from 10 to 200% by mol, still preferably from 20 to 200% by moll, still preferably from 50 to 150% by mol and particularly preferably from 50 to 120% by mol, based on the hydrolyzable group.

The treatment is carried out by stirring at 15 to 100° C., though it is favorable to control the treating conditions depending on the reactivity of the organosilane compound.

From the viewpoints of the condensation reaction speed and the membrane strength after forming a coating membrane, the metal chelate compound according to the invention is employed preferably in an amount of from 0.01 to 50% by mass, still preferably from 0.1 to 50% by mass and still preferably from 0.5 to 10% by mass based on the organosilane.

(Dispersion Stabilizer)

It is preferable that the dispersion or the coating composition to be used in the invention contains, in addition to the organosilane compound and the acid catalyst or the metal chelate compound as described above, a β-diketone compound and/or a β-ketoester compound represented by R⁴COCH₂COR⁵. Such a compound serves as a stabilizer improving agent for the dispersion or the coating composition to be used in the invention. Namely, it is considered that coordination to the metal atom in the above-described metal chelate compound (preferably a zirconium, titanium and/or aluminum compound) would regulate the effect of the metal chelate compound of promoting the condensation reaction of the organosilane and the metal chelate component, thereby improving the storage stability of the obtained composition. R⁴ and R⁵ in the compound represented by R⁴COCH₂COR⁵ have the same meanings as R⁴ and R⁵ constituting the metal chelate compound as described above.

Specific examples of these β-diketone compound and/or β-ketoester compound represented by R⁴COCH₂COR⁵ include acetylacetone, methyl acetoacetate, ethyl acetoacetate, n-propyl acetoacetate, i-propyl acetoacetate, n-butyl acetoacetate, sec-butyl acetoacetate, t-butyl acetoacetate, 2,4-hexandione, 2,4-heptandione, 3,5-heptandione, 2,4-octandione, 2,4-nonandione, and 5-methylhexan-dione. Among these compounds, ethyl acetoacetate and acetylacetone are preferable and acetylacetone is particularly preferred. Either one of these β-diketone compounds and/or β-ketoester compounds or a mixture of two or more thereof may be used. In the invention, such β-diketone compounds and/or β-ketoester compounds are used in an amount of 2 mol or more, preferably from 3 to 20 mol per mol of the metal chelate compound. It is not favorable to use such compounds in an amount less than 2 mol, since it is feared that the obtained composition has a poor storage stability in this case.

[Low Refractive Index Layer]

Next, the low refractive index layer of the antireflective film according to the invention will be illustrated.

The refractive index of the low refractive index layer of the antireflective film according to the invention ranges from 1.20 to 1.49, preferably from 1.38 to 1.49, more preferably from 1.38 to 1.44. From the viewpoint of achieving a low refractive index, it is favorable that the low refractive index layer satisfies the following numerical formula (I).
(mλ/4)×0.7<n1d1<(mλ/4)×1.3 numerical formula (I)

In this formula, m is a positive odd number, n1 represents the refractive index of the low refractive index layer and d1 represents the membrane thickness (nm) of the low refractive index layer. λ represents a wavelength falling within the range of from 500 to 550 nm. Satisfying the numerical formula (I) means that there is m (i.e., a positive odd number, usually being 1) satisfying the numerical formula (I) within the wavelength range as described above.

Next, materials forming the low refractive index layer according to the invention will be illustrated.

It is preferable that the low refractive index layer contains, as a binder, a monomer or a polymer undergoing crosslinkage by heating or ionizing radiation.

The monomer and polymer undergoing crosslinkage by heating or ionizing radiation to be used in the low refractive index layer are not particularly restricted. Similar to the case of the high (medium) refractive index layer as will be described hereinafter, a polyfunctional monomer hardening (curing) due to ionizing radiation is preferred as the monomer. As the polymer, a crosslinkable fluorine-containing compound is preferred.

Preferred embodiments of the binder that contains a hardening (curing) compound are mentioned below.

(1) A composition comprising, as the principal ingredient thereof, (A) a fluorine-containing polymer that has a crosslinking or polymerizing functional group;

(2) A composition containing (B) a monomer that has two or more ethylenic unsaturated groups and (C) a polymerization initiator.

The fluorine-containing polymer (A) is described.

The polymer is preferably a crosslinkable fluorine-containing compound. Examples thereof include perfluoroalkyl group-containing silane compounds (for example, (heptadecafluoro-1,1,2,2-tetrahydrodecyl)triethoxysilane) and fluorine-containing copolymers comprising a fluorine-containing monomer and another monomer for imparting crosslinking reactivity. Specific examples of the fluorine-containing monomer include fluoroolefins (for example, fluoroethylene, vinylidene fluoride, tetrafluoroethylene, hexafluoropropylene and perfluoro-2,2-dimethyl-1,3-dioxol), partly or completely fluorinated alkyl ester derivatives of (meth)acrylic acid (for example, BISCOAT 6FM® manufactured by OSAKA YUKI CHEMICAL Co., Ltd. and M-2020® manufactured by DAIKIN INDUSTRIES, LTD.) and completely or partly fluorinated vinyl ethers. Examples of the monomer for imparting crosslinking reactivity a (meth)acrylate monomer preliminarily having a self-crosslinkable functional group in its molecule such as glycidyl (meth)acrylate and a (meth)acrylate monomer having a carboxyl group, a hydroxy group, an amino group, a sulfo group or the like (for example, (meth)acrylic acid, methylol (meth)acrylate, hydroxyalkyl (meth)acrylate, allyl acrylate and so on). It is stated in JP-A-10-25388 and JP-A-10-147739 that a crosslinkage structure can be introduced into the latter monomers after copolymerization.

This is described in more detail hereinunder.

<Fluorine-Containing Polymer>

Preferably, the fluorine-containing polymer is as follows, from the viewpoint of improving the producibility in applying the polymer onto a roll film being conveyed in the form a web thereof and hardening it thereon: The hardened (cured) coating film of the polymer has a kinematic friction factor of from 0.03 to 0.20, a contact angle to water of from 90 to 120°, and a pure water slip angle of at most 70°; and the polymer is crosslinkable when exposed to heat or ionizing radiations.

In case where the antireflection film of the invention is fitted to an image display device, seals and adhesive memo sheets stuck thereto may be more readily peeled off when the peeling strength of the film from a commercially-available adhesive tape is lower. Therefore, the peeling strength of the film is preferably at most 500 gf, more preferably at most 300 gf, most preferably at most 100 gf. The film is more hardly scratched when its surface hardness as measured with a microhardness meter is higher. Therefore, the surface hardness of the film is preferably at least 0.3 GPa, more preferably at least 0.5 GPa.

The fluorine-containing polymer for use in the low refractive index layer is a fluorine-containing polymer that contains a fluorine atom within a range of from 35 to 80% by mass and contains a crosslinking or polymerizing functional group, including, for example, hydrolyzates and hydrolytic dewatering condensates of perfluoroalkyl group-containing silane compounds (e.g., heptadecafluoro-1,1,2,2-tetrahydrodecyl)triethoxysilane), as well as fluorine-containing copolymers that comprise, as the constitutive components thereof, fluorine-containing monomer units and crosslinking-reactive units. Preferably, the backbone chain of the fluorine-containing copolymers is formed of only carbon atoms. Preferably, in other words, the backbone chain of the copolymers does not contain an oxygen atom and a nitrogen atom.

Specific examples of the fluorine-containing monomer units are fluoro-olefins (e.g., fluoroethylene, vinylidene fluoride, tetrafluoroethylene, perfluoro-octylethylene, hexafluoropropylene, perfluoro-2,2-dimethyl-1,3-dioxol), partially or completely fluorinated alkyl ester derivatives of (meth)acrylic acid (e.g., Biscoat 6FM (by Osaka Yuki Kagaku), M-2020 (by Daikin)), and completely or partially fluorinated vinyl ethers. Preferred are perfluoro-olefins; and more preferred is hexafluoropropylene from the viewpoint of the refractivity, solubility, transparency and availability thereof. When the compositional ratio of the fluorine-containing vinyl monomer is increased, then the refractive index of the coating film may be lowered but the strength thereof may decrease. Preferably in the invention, the fluorine-containing vinyl monomer is introduced into the copolymer in such a controlled manner that the fluorine content of the copolymer could be from 20 to 60% by mass, more preferably from 25 to 55% by mass, even more preferably from 30 to 50% by mass.

The structural units for imparting crosslinking reactivity to the polymer are principally the following units (a), (b) and (c):
(a) structural units formed through polymerization of a monomer that intrinsically has a self-crosslinking functional group in the molecule, such as glycidyl (meth)acrylate or glycidyl vinyl ether;
(b) structural units formed through polymerization of a monomer having a carboxyl group, a hydroxyl group, an amino group or a sulfo group (e.g., (meth)acrylic acid, methylol (meth)acrylate, hydroxyalkyl (meth)acrylate, allyl acrylate, hydroxyethyl vinyl ether, hydroxybutyl vinyl ether, maleic acid, crotonic acid);
(c) structural units formed through reaction of a compound having a group capable of reacting with the functional group in (a) or (b) and, apart from it, further having a crosslinking functional group in the molecule, with the structural unit of (a) or (b) (e.g., structural units formed in a mode of reaction of a hydroxyl group with acrylic acid chloride).

For the structural units (c) in the invention, the crosslinking functional group is more preferably a photopolymerizing group. The photopolymerizing group includes, for example, a (meth)acryloyl group, an alkenyl group, a cinnamoyl group, a cinnamylidenacetyl group, a benzalacetophenone group, a styrylpyridyl group, an α-phenylmaleimido group, a phenylazido group, a sulfonylazido group, a carbonylazido group, a diazo group, an o-quinonediazido group, a furylacryloyl group, a coumaryl group, a pyronyl group, an anthracenyl group, a benzophenone group, a stilbene group, a dithiocarbamate group, a xanthate group, a 1,2,3-thiadiazole group, a cyclopropenyl group, an azadioxabicyclo group. Not only one but also two or more of these groups may constitute the unit. Of those, preferred are a (meth)acryloyl group and a cinnamoyl group; and more preferred is a (meth)acryloyl group.

Concrete methods for preparing the photopolymerizing group-containing copolymers are mentioned below, to which, however, the invention should not be limited.

(1) A method of reacting a hydroxyl group-containing and crosslinking functional group-containing copolymer with (meth)acrylic acid chloride to esterify the copolymer;

(2) A method of reacting a hydroxyl group-containing and crosslinking functional group-containing copolymer with an isocyanate group-containing (meth)acrylate to urethanate the copolymer;

(3) A method of reacting an epoxy group-containing and crosslinking functional group-containing copolymer with (meth)acrylic acid to esterify the copolymer;

(4) A method of reacting a carboxyl group-containing and crosslinking functional group-containing copolymer with an epoxy group-containing (meth)acrylate to esterify the copolymer.

The amount of the photopolymerizing group to be introduced into the copolymer may be controlled in any desired manner, and it will be desirable to make the copolymer still have a predetermined amount of a carboxyl group and a hydroxyl group remaining therein from the viewpoint of ensuring the coating film surface stability, preventing the surface failure when the film contains inorganic fine particles therein, and increasing the film strength.

In addition to the copolymer of the above-described fluorine-containing monomer with the monomer for imparting crosslinking reactivity, it is also possible to employ copolymer containing an additional monomer having been copolymerized. Plural vinyl monomers may be combined depending on the object of the copolymer. Preferably, from 0 to 65 mol %, more preferably from 0 to 40 mol %, even more preferably from 0 to 30 mol % in total of the monomers are in the copolymer. Such a monomer usable together is not particularly restricted. Namely, examples thereof include olefins (for example, ethylene, propylene, isoprene, vinyl chloride and vinylidene chloride), acrylic acid esters (for example, methyl acrylate, ethyl acrylate and 2-ethylhexyl acrylate), methacrylic acid esters (for example, methyl methacrylate, ethyl methacrylate, butyl methacrylate and ethylene glycol dimethacrylate), styrene derivatives (for example, styrene, divinylbenzene, vinyltoluene and α-methylstyrene), vinyl ethers (for example, methyl vinyl ether, ethyl vinyl ether, cyclohexyl vinyl ether, hydroxyethyl vinyl ether, hydroxybutyl vinyl ether), vinyl esters (for example, vinyl acetate, vinyl propionate and vinyl cinnamate), unsaturated carboxylic acids (for example, acrylic acid, methacrylic acid, crotonic acid, maleic acid, itaconic acid), acrylamides (for example, N-tert-butylacrylamide and N-cyclohexylacrylamide), methacrylamides and acrylonitrile derivatives. Copolymers described in paragraphs [0030] to [0047] in JP-A-2004-45462 may be cited as binders preferably usable in the low refractive index layer according to the invention.

The fluorine-containing polymer especially useful in the invention is a random copolymer of a perfluoroethylene with a vinyl either or vinyl ester. Especially preferably, the polymer has a group crosslinkable by itself (e.g., radical-reactive group such as (meth)acryloyl group, and ring-cleaving polymerizing group such as epoxy group, oxetanyl group). It is desirable that the crosslinking-reactive group-containing polymerization units account for from 5 to 70 mol %, more preferably from 30 to 60 mol % of all the polymerization units. Polymers preferred for use in the invention are described in JP-A 2002-243907, 2002-372601, 2003-26732, 2003-222702, 2003-294911, 2003-329804, 2004-4444, 2004-45462.

Preferably, a polysiloxane structure is introduced into the fluorine-containing polymer for use in the invention, for the purpose of imparting stain resistance to the film of the invention. The method for introducing a polysiloxane structure into the polymer is not specifically defined. For example, preferably employed herein are a method of introducing a polysiloxane block copolymer component by the use of a silicone macroazo initiator, as in JP-A 6-39100, 11-189621, 11-228631, 2000-313709; and a method of introducing a polysiloxane graft copolymer component by the use of a silicone macromer, as in JP-A 2-251555, 2-308806. Especially preferred compounds for use herein are the polymers in Examples 1, 2 and 3 in JP-A 11-189621, and the copolymers A-2 and A-3 in JP-A 2-251555. Preferably, the polysiloxane component is in the polymer in an amount of from 0.5 to 10% by mass, more preferably from 1 to 5% by mass.

The polymer preferred for use in the invention preferably has a mass-average molecular weight of at least 5,000, more preferably from 10,000 to 500,000, most preferably from 15,000 to 200,000. Polymers that differ in point of their average molecular weight may be combined for use herein, for the purpose of improving the coating film surface condition and improving the scratch resistance of the film.

One preferred embodiment of the copolymer for use in the invention is represented by the following formula (1):

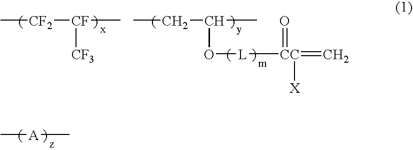

In formula (1), L represents a linking group having from 1 to 10 carbon atoms, preferably from 1 to 6 carbon atoms, more preferably from 2 to 4 carbon atoms, and it may have a linear structure, or a branched structure, or a cyclic structure, and it may contain a hetero atom selected from O, N and S.

Preferred examples of L are *—(CH₂)₂—O—**, *—(CH₂)₂—NH—**, *—(CH₂)₄—O—**, *—(CH₂)₆—O—**, *—(CH₂)₂—O—(CH₂)₂—O—**, *—CONH—(CH₂)₃—O—**, *—CH₂CH(OH)CH₂—O—**, *—CH₂CH₂OCONH(CH₂)₃—O—** (in which * indicates the linking site on the backbone structure side of the polymer; and ** indicates the linking side on the (meth)acryloyl group side thereof). m indicates 0 or 1.

In formula (1), X represents a hydrogen atom or a methyl group. From the viewpoint of the hardening (curing) reactivity of the polymer, X is preferably a hydrogen atom.

In formula (1), A represents a repetitive unit derived from a vinyl monomer, and, not specifically defined, it may be any constitutive component of a monomer copolymerizable with hexafluoropropylene. From the viewpoint of the adhesiveness of the polymer to the underlying layer in a case where a low refractive index layer is formed on the surface of the substrate, Tg of the polymer (this contributes to the film hardness), the solubility thereof in solvent, the transparency thereof, the lubricity thereof, and the dust resistance and the stain resistance thereof, the unit A may be suitably selected. Depending on the object of the polymer, one or more different types of vinyl monomers may form the repetitive unit A.

Preferred examples of the vinyl monomer are vinyl ethers such as methyl vinyl ether, ethyl vinyl ether, t-butyl vinyl ether, cyclohexyl vinyl ether, isopropyl vinyl ether, hydroxyethyl vinyl ether, hydroxybutyl vinyl ether, glycidyl vinyl ether, allyl vinyl ether; vinyl esters such as vinyl acetate, vinyl propionate, vinyl butyrate; (meth)acrylates such as methyl (meth)acrylate, ethyl (meth)acrylate, hydroxyethyl (meth)acrylate, glycidyl methacrylate, allyl (meth)acrylate, (meth)acryloyloxypropyltrimethoxysilane; styrene derivatives such as styrene, p-hydroxymethylstyrene; unsaturated carboxylic acids and their derivatives such as crotonic acid, maleic acid, itaconic acid. More preferred are vinyl ether derivatives and vinyl ester derivatives; and even more preferred are vinyl ether derivatives.

In formula (1), x, y and z each indicates the mol % of the constitutive components, and preferably satisfy the following: 30≦x≦60, 5≦y≦70, 0≦z≦65. More preferably, 35≦x≦55, 30≦y≦60, 0≦z≦20; even more preferably 40≦x≦55, 40≦y≦55, 0≦z≦10. In this, x+y+z=100.

A more preferred embodiment of the copolymer for use in the invention is represented by the following formula (2):

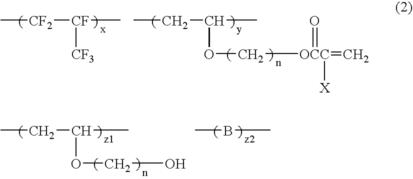

In formula (2), X has the same meaning as that in formula (1), and its preferred ranges are also the same as in formula (1).

n indicates an integer of 2≦n≦10, preferably 2≦n≦6, more preferably 2≦n≦4.

B represents a repetitive unit derived from a vinyl monomer, and it may be composed of a single composition or multiple compositions. For its examples, referred to are those mentioned hereinabove for A in formula (1).

x, y, z1 and z2 each indicates the mol % of the repetitive units. Preferably, x and y satisfy 30≦x≦60 and 5≦y≦70, more preferably 35≦x≦55 and 30≦y≦60, even more preferably 40≦x≦55 and 40≦y≦55. Preferably, z1 and z2 satisfy 0≦z1≦65 and 0≦z2≦65, more preferably, 0≦z1≦30 and 0≦z2≦10, even more preferably 0≦z1≦10 and 0≦z2≦5. In this, x+y+z1+z2=100.

The copolymers of formula (1) or (2) can be produced, for example, by introducing a (meth)acryloyl group into a copolymer that contains a hexafluoropropylene component and a hydroxyalkyl vinyl ether component, according to any of the above-mentioned methods. For the re-precipitation solvent for use in the case, preferred are isopropanol, hexane and methanol.

A polymerizing unsaturated group-having hardening (curing) agent may be suitably used for the polymer, as in JP-A 10-25388 and 2000-17028. Preferably, the polymer may be combined with a fluorine-containing and polyfunctional polymerizing unsaturated group-containing compound, as in JP-A 2002-145952. Examples of the polyfunctional polymerizing unsaturated group-having compound are monomers (B) having two or more ethylenic unsaturated groups that are mentioned below. The compound is especially preferable as significantly effective for improving the scratch resistance of films when combined with a polymerizing unsaturated group-having compound for the polymer skeleton.

Preferably, the compound is used in an amount of from 1 to 50 parts by mass, more preferably from 2 to 40 parts by mass, most preferably from 3 to 30 parts by mass relative to 100 parts by mass of the polymer skeleton.

A crosslinking compound may be combined with the polymer for further enhancing the hardenability (curing ability) of the polymer. For example, when the polymer skeleton contains a hydroxyl group, then various types of amino compounds are preferably used for the hardening agent for it. For example, the amino compounds usable as the crosslinking compound are those having at least two groups in total of either one or both of a hydroxyalkylamino group and an alkoxyalkylamino group. Concretely, for example, they are melamine compounds, urea compounds, benzoguanamine compounds, and glycolurea compounds.

The melamine compounds are generally known as those having a skeleton of a triazine ring with a nitrogen atom bonding thereto, concretely including melamine, alkylated melamine, methylolmelamine, and alkoxylated methylmelamine. Preferred are those having at least two groups in total of either one or both of a methylol group and an alkoxylated methyl group in one molecule. Concretely preferred are methylolated melamine, alkoxylated methylmelamine and their derivatives that are obtained through reaction of melamine and formaldehyde under a basic condition. More preferred is alkoxylated methylmelamine as it may improve the storage stability and the reactivity of the hardening composition containing it. The methylolated melamine and the alkoxylated methylmelamine herein usable as the crosslinking compound are not specifically defined. For example, various resin materials obtainable according to the methods described in a reference, Plastic Zairyo Kohza [8] Urea Melamine Jushi (by Nikkan Kogyo Shinbun) may be used herein.

The urea compounds include urea, as well as polymethylolated urea and its derivatives, alkoxylated methylurea, urone ring-having methylolated urone and alkoxylated methylurone. For the urea derivatives, also usable herein are various resin materials described in the above-mentioned reference.

Preferably, the crosslinking compound is used in an amount of from 1 to 50 parts by mass, more preferably from 5 to 40 parts by mass, most preferably from 10 to 30 parts by mass relative to 100 parts by mass of the polymer skeleton.

The monomer (B) having two or more ethylenic unsaturated groups is described.

<Monomer Having Two or More Ethylenic Unsaturated Groups>

The monomer having two or more ethylenic unsaturated groups includes, for example, esters of polyalcohol with (meth)acrylic acid [for example, ethylene glycol di(meth)acrylate, butanediol di(meth)acrylate, hexanediol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, polyester polyacrylate], ethyleneoxide-modified derivatives of the esters, vinylbenzene and its derivatives [for example, 1,4-divinylbenzene, 2-acryloylethyl 4-vinylbenzoate, 1,4-divinylcyclohexanone] vinyl sulfones (for example, divinyl sulfone), acrylamides (for example, methylenebisacrylamide) and metliacrylamides. Two or more different types of these monomers may be combined for use herein. The monomer may increase the density of the crosslinking group in the binder comprising it, therefore effective for forming hardened (cured) films having a high hardness. However, as compared with that of the film that comprises a fluorine-containing polymer binder, the refractive index of the film that comprises the binder of the type is not low. In the invention, the binder is combined with inorganic fine particles having a hollow structure, and therefore the film that comprises the binder may have a refractive index enough for the low refractive index layer in the invention.

In the low refractive index layer according to the invention, use can be made of a publicly known silicone-base, fluorine-base or fluoroalkyl silicone-base compound. In the case of using such an additive, it is preferably added in an amount of from 0.01 to 20% by mass, still preferably from 0.05 to 10% by mass and particularly preferably from 0.1 to 5% by mass, based on the total solid components in the low refractive index layer.

(Method of Forming Low Refractive Index Layer)

It is preferable to form the low refractive index layer by applying a coating composition prepared by mixing the above-described binder, inorganic fine particles and other additives with an organic solvent, drying and then hardening. In the case of using a light-hardening (light-curing) binder, it is preferable that, after the application and drying, the coating composition is hardened (cured) by heating at 80 to 150° C. for 1 to 30 minutes. In the case of using a light-hardening (curing) binder, it is also preferable to add a photopolymerization initiator, which will be described hereinafter concerning the hard coat layer, to the coating solution.

[Hard Coat Layer]

Next, the hard coat layer constituting the antireflective film according to the invention will be illustrated.

The hard coat layer can be formed by combining the binder for imparting hard coat properties with optional components selected from among matting particles for imparting antiglare properties or internal scattering properties and an inorganic filler for achieving a high refractive index, preventing crosslinking shrinkage or enhancing the strength. As the binder, it is preferable to use a polymer having a saturated hydrocarbon chain or a polyether chain as the main chain and a polymer having a saturated hydrocarbon chain is still preferable. It is also preferable that the binder polymer has a crosslinked structure. As the binder polymer having a saturated hydrocarbon chain as the main chain, a polymer of an ethylenically unsaturated monomer is preferred. As the binder polymer having a saturated hydrocarbon chain as the main chain and a crosslinked structure, a (co)polymer of monomer(s) having two or more ethylenically unsaturated bonds is preferable. To achieve a high refractive index, it is preferable to select a monomer having an aromatic ring or at least one atom selected from among halogen atoms other than fluorine, sulfur atom, phosphorus atom and nitrogen atom in its structure.

Examples of the monomer having two or more ethylenically unsaturated bonds include esters of polyhydric alcohol with (meth)acrylic acid (for example, ethylene glycol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, 1,3,5-cyclohexanetriol triacrylate, polyurethane polyacrylate and polyester polyacrylate), divinyl benzene and its derivatives (for example, 1,4-divinyl benzene, 4-vinylbenzoic acid-2-acryloylethyl ester and 1,4-divinyl cyclohexanone), vinyl sulfones (for example, divinyl sulfone), and acrylamides (for example, methylenebisacrylamide).

Specific examples of the monomer having high refractive index include bis(4-methacryloylthiophenyl) sulfide, vinyl naphthalene, vinyl phenyl sulfide and 4-methacryloyloxyphenyl-4′-methoxyphenyl thioether.

Such a monomer having ethylenically unsaturated bonds can be polymerized by ionizing radiation or heating in the presence of a photo radical polymerization initiator or a heat radical polymerization initiator. That is to say, an antireflective film can be formed by preparing a coating solution, which contains the monomer having ethylenically unsaturated bonds, a photo radical polymerization initiator or a heat radical polymerization initiator, matting particles and inorganic fine particles inorganic filler, then applying the coating solution to transparent support, hardening the same by polymerization under ionizing radiation or heating.

As the binder polymer having polyether as the main chain, it is preferable to employ a ring-opening polymer of a polyfunctional epoxy compound. The ring-opening polymerization of the polyfunctional epoxy compound can be carried out by ionizing radiation or heating in the presence of a photo acid generator or a heat acid generator. That is to say, a coating solution, which contains the polyfunctional epoxy compound, a photo acid generator or a heat acid generator, matting particles and inorganic fine particles, is prepared. Then the coating solution is applied to a transparent support and then hardened by polymerization under ionizing radiation or heating. Thus, an antireflective film can be formed.

Use can be made of two or more polyfunctional monomers.

As the functional group in the polyfunctional monomer or the polyfunctional oligomer hardened by ionizing radiation for forming the above-described binder, those polymerizable due to heat, electron beams or radiation are preferable and photo polymerizable functional groups are still preferable. Examples of the photo polymerizable functional groups include unsaturated polymerizable functional groups such as (meth)acryloyl group, vinyl group, styryl group and allyl group. Among all, (meth)acryloyl group is preferred.

In polymerizing the photo polymerizable polyfunctional monomer, it is preferable to use a photo polymerization initiator. As the photo polymerization initiator, a photo radical polymerization initiator and a photo cation polymerization initiator are preferable and a photo radical polymerization initiator is still preferable.

As the photo radical polymerization initiator, use can be made of acetophenones, benzophenones, Michler's benzoyl benzoate, α-amyloxime ester, tetramethyl thiuram sulfide and thioxanthons.

Examples of commercially available photo radical polymerization initiators include KAYACURES (DETX-S, BP-100, BDMK, CTX, BMS, 2-EAQ, ABQ, CPTX, EPD, ITX, QTX, BTC, MCA and so on, manufactured by NIPPON KAYAKU Co., Ltd.), IRGACURES (651, 184, 500, 907, 369, 1173, 2959, 4265, 4263 and so on, (manufactured by Ciba Specialty Chemicals) and Es a cures (KIP100F, KB1, EB3, BP, X33, KT046, KT37, KIP150 and TZT, manufactured by Sartomer Co.).

It is particularly preferable to use a photo radical polymerization initiator of the photo cleavage type. Photo radical polymerization initiators of the photo cleavage are reported in Saishin UV Koka Gijutsu, (p. 159, publisher: Kazuhiro Takausu, publishing office: GIJUTSU KYOKAI K. K., 1991).

As preferable examples of commercially available photo radical polymerization initiators of the photo cleavage type, IRGACURES (651, 184, 907) (manufactured by Ciba Specialty Chemicals) may be cited.

The photo polymerization initiator is used preferably in an amount of from 0.1 to 15 parts by mass, still preferably from 1 to 10 parts by mass, per 100 parts by mass of the polyfunctional monomer.

In addition to the photo polymerization initiator, use may be made of a photo sensitizer. Specific examples of the photo sensitizer include n-butylamine, triethylamine, tri-n-butylphosphine, Micheler's ketone and thioxanthone.

Examples of commercially available photo sensitizers include KAYACURES (DMBI and EPA) manufactured by NIPPON KAYAKU Co., Ltd. and so on.

It is preferable to perform the photo polymerization by irradiating ultraviolet light after applying and drying the hard coat layer.

It is also possible to use a monomer having a crosslinking functional group, as a substitute for the monomer having two or more ethylenically unsaturated bonds or in addition thereto, to thereby introduce the crosslinking functional group into the polymer. Thus, a crosslinked structure can be introduced into the binder polymer owing to the reaction of this crosslinking functional group. Examples of the crosslinking functional group include an isocyanate group, an epoxy group, an aziridine group, an oxazoline group, an aldehyde group, a carbonyl group, a hydrazine group, a carboxyl group, a methylol group and an active methylene group. As a monomer for introducing a crosslinked structure, use can be also made of vinylsulfonic acid, acid anhydrides, cyanoacrylate derivatives, melamine, etherified methylol, esters and urethane and metal alkoxides such as tetramethoxysilane. It is also possible to use a functional group that shows crosslinking ability as the result of a decomposition reaction, for example, a blocked isocyanate group. Namely, the crosslinking functional group to be used in the invention may be either one showing an immediate reactivity or one showing a reactivity after decomposition. The binder polymer containing such a crosslinking functional group can form a crosslinked structure by heating after the application.

To impart antiglare properties or inner scattering properties, the hard coat layer contains, if necessary, matting particles having an average particle size of from 1 to 10 μm, preferably from 1.5 to 7.0 μm, such as particles of an inorganic compound or resin particles. Specific examples of the matting particles include particles of inorganic compounds such as silica particles and TiO₂ particles; and resin particles such as crosslinked acryl particles, crosslinked acryl-styrene particles, crosslinked styrene particles, melamine resin particles and benzoguanamine resin particles. Among all, crosslinked acryl particles, crosslinked acryl-styrene particles and crosslinked styrene particles are preferred. These matting particles may be either spherical or irregular-shaped. Also, use can be made of two or more types of different matting particles. These matting particles are used in such an amount that the content of the matting particles in the antiglare hard coat layer thus formed preferably ranges from 10 to 1000 mg/m², still preferably from 30 to 100 mg/m². In a particularly preferred embodiment, crosslinked styrene particles are used as the matting particles and crosslinked styrene particles having particle size larger than ½ of the membrane thickness of the hard coat layer amount to 40 to 100% of the total crosslinked styrene particles. The particle size distribution of the matting particles is determined by measuring with a Coulter's counter and converting the measured distribution into particle count distribution.

To elevate the refractive index of the layer, the hard coat layer preferably contains, in addition to the matting particles as described above, inorganic fine particles which comprise oxide of at least one metal selected from among titanium, zirconium, aluminum, indium, zinc, tin and antimony and preferably have an average particle size of from 0.001 μm to 0.2 μm, still preferably 0.001 μm to 0.1 μm and still preferably from 0.001 to 0.06 μm. Specific examples of the inorganic fine particles to be used in the hard coat layer include TiO₂, ZrO₂, Al₂O₃, In₂O₃, ZnO, SnO₂, Sb₂O₃, ITO (indium-tin oxide) and so on. TiO₂ and ZrO₂ are preferred from the viewpoint of elevating refractive index. It is also preferable that these inorganic fine particles are surface-treated by silane coupling or titanium coupling. Use is preferably made of a surface-treating agent having a functional group capable of reacting with the binder on the filler surface.

The content of such inorganic fine particles is preferably from 10 to 90% based on the total mass of the hard coat layer, still preferably from 20 to 80% and particularly preferably from 30 to 75%.

Because of having a particle size sufficiently smaller than the light wavelength, the inorganic fine particles cause no scattering. Therefore, a dispersion having the filler dispersed throughout the binder polymer behaves as an optically homogeneous substance.

The refractive index of the mixture of the binder and the inorganic fine particles in the hard coat layer preferably ranges from 1.57 to 2.00, still preferably from 1.60 to 1.80. The refractive index can be controlled within the range as specified above by appropriately selecting the types and mixing ratio of the binder and the inorganic fine particles. It can be easily understood through preliminary experiments how to select them.

The membrane thickness of the hard coat layer is preferably form 1 to 10 μm, still preferably form 1.2 to 6 μm.

[High (Medium) Refractive Index Layer]

In the case of applying the invention to a high refractive index layer, the refractive index preferably ranges from 1.65 to 2.40, still preferably from 1.70 to 2.20. In the case of using a medium refractive index layer, its refractive index is controlled to a level between the refractive index of the low refractive index layer and the refractive index of the high refractive index layer. The refractive index of the medium refractive index layer preferably ranges from 1.55 to 1.80. It is also preferable that the high refractive index layer and the medium refractive index layer have each a haze of 3% or less.

In the high refractive index layer and the medium refractive index layer serving as optically functional layers in the invention, it is preferable to use a hardened product of a composition in which inorganic fine particles with a high refractive index are dispersed in a monomer, an initiator and an organosilane compound as will be described hereinafter. As the inorganic fine particles, metal (for example, aluminum, titanium, zirconium or antimony) oxides are preferable and titanium dioxide fine particles are most desirable from the viewpoint of refractive index. In the case of using a monomer and an initiator, the monomer is hardened via polymerization by ionizing radiation or heating after the application. Thus, a medium refractive index layer or a high refractive index layer being excellent in scratch resistance and adhesiveness can be formed. The average particle diameter of the inorganic fine particles preferably ranges from 10 to 100 nm.

As the titanium dioxide fine particles as described above, inorganic fine particles containing titanium dioxide as the main component together with at least one element selected from among cobalt, aluminum and zirconium are particularly preferred. The term “main component” means the component having the largest content (% by mass) among the components constituting the particles.

The inorganic fine particles containing titanium dioxide as the main component according to the invention preferably have a refractive index of from 1.90 to 2.80, still preferably from 2.10 to 2.80 and most desirably from 2.20 to 2.80.

The mass-average particle diameter of the inorganic fine particles containing titanium dioxide as the main component preferably ranges from 1 to 200 nm, still preferably from 1 to 150 nm and particularly preferably from 1 to 80 nm.

The particle diameter of the inorganic fine particles can be measured by the light scattering method or electron microscopic photography. The specific surface area of the inorganic fine particles preferably ranges from 10 to 400 m²/g, still preferably from 20 to 200 m²/g and most desirably from 30 to 150 m²/g.

It is preferable that the inorganic fine particles containing titanium dioxide as the main component have a crystalline structure mainly comprising rutile, mixed crystals of rutile with anatase, anatase or amorphous structure. It is particularly preferable to contain rutile structure as the main component. The term “main component” means the component having the largest content (% by mass) among the components constituting the particles.

By adding at least one element selected from Co (cobalt), Al (aluminum) and Zr (zirconium) to the inorganic fine particles containing titanium dioxide as the main component, the photo catalytic activity of the titanium dioxide can be regulated and thus the weatherability of the high refractive index layer and the medium refractive index layer according to the invention can be improved.

Co (cobalt) is a particularly preferable element. It is also preferred to use two or more elements.

(Dispersing Agent for Inorganic Fine Particles)

To disperse the inorganic fine particles containing titanium dioxide as the main component to be used in the high refractive index layer and the medium refractive index layer according to the invention, a dispersing agent can be employed.

To disperse the inorganic fine particles containing titanium dioxide as the main component according to the invention, it is particularly preferable to employ a dispersing agent having an anionic group.

Examples of anionic groups effective therefor include acidic groups having proton such as carboxyl group, sulfonate group (and sulfo group), phosphate group (and phosphono group) and sulfonamide group and salts thereof. In particular, carboxyl group, sulfonate group, phosphonate group and salts thereof are preferable and carboxyl group and phosphate group are still preferable. The dispersing agent may carry one or more anionic groups per molecule.

To further improve the dispersibility of the inorganic fine particles, a plurality of anionic groups may be contained. Namely, it is preferable that the dispersing agent has two or more anionic group on average, still preferably five or more and particularly preferably ten or more. It is also possible that the dispersing agent has two or more types of anionic groups per molecule.

It is preferable that the dispersing agent further has a polymerizable functional group. Examples of the crosslinkable or polymerizable functional group include ethylenically unsaturated groups capable of undergoing addition/polymerization due to radical species (for example, (meth)acryloyl group, allyl group, styryl group and vinyl oxy group), cationic polymerizable groups (epoxy group, oxatanyl group, vinyloxy group and so on), polycondensation groups (hydrolyzable silyl group, N-methylol group and so on) and the like. A functional group having an ethylenically unsaturated group is preferred.

As the dispersing agent to be used for dispersing the inorganic fine particles containing titanium dioxide as the main component to be used in the high refractive index layer according to the invention, a dispersing agent which has an anionic group and a crosslinkable or polymerizable group and in which the crosslinkable or polymerizable group is contained in its side chain.

The mass-average molecular weight (Mw) of the dispersing agent which has an anionic group and a crosslinkable or polymerizable group and in which the crosslinkable or polymerizable group is contained in its side chain is preferably 1000 or more, though the invention is not restricted thereto. It is still preferable that the mass-average molecular weight (Mw) of the dispersing agent ranges from 2000 to 1000000, still preferably from 5000 to 200000 and particularly preferably from 10000 to 100000.

The dispersing agent is used preferably in an amount of from 1 to 50% by mass based on the inorganic fine particles, still preferably from 5 to 30% by mass and most desirably from 5 to 20% by mass. It is also possible to use two or more dispersing agents together.

(Method of Dispersing Inorganic Fine Particles)

The inorganic fine particles containing titanium dioxide as the main component to be used in the high refractive index layer and the medium refractive index layer are employed in the state of a dispersion in forming the high refractive index layer and the medium refractive index layer.

The inorganic fine particles are dispersed in a dispersion medium in the presence of the dispersing agent as described above.

As the dispersion medium, use is preferably made of a liquid having a boiling point of form 60 to 170° C. Examples of the dispersion medium include water, alcohols (for example, methanol, ethanol, isopropanol, butanol and benzyl alcohol), ketones (for example, acetone, methyl ethyl ketone, methyl isobutyl ketone and cyclohexanone), esters (for example, methyl acetate, ethyl acetate, propyl acetate, butyl acetate, methyl formate, ethyl formate, propyl formate and butyl formate), aliphatic hydrocarbons (for example, hexane and cyclohexane), halogenated hydrocarbons (for example, methylene chloride, chloroform and carbon tetrachloride), aromatic hydrocarbons(for example, benzene, toluene and xylene), amides (for example, dimethylformamide, dimethylacetamide and n-methylpyrrolidone), ethers (for example, diethyl ether, dioxane and tetrahydrofuran), and ether alcohols (for example, 1-methoxy-2-propanol). Among all, toluene, xylene, methyl ethyl ketone, methyl isobutyl ketone, cyclohexanone and butanol are preferred.

As particularly preferable dispersion media, methyl ethyl ketone, methyl isobutyl ketone and cyclohexanone may be cited.

The inorganic fine particles are dispersed with the use of a dispersion machine. Examples of the dispersion machine include a sand grinder mill (for example, a bead mill provided with pins), a high-speed impeller mill, a pebble mill, a roller mill, an attritor and a colloid mill. Among all, a sand grinder mill and a high-speed impeller mill are preferred. It is also possible to carry out a pre-dispersion treatment. Examples of the dispersion machine to be used in the pre-dispersion treatment include a ball mill, a three-roll mill, a kneader and an extruder.

It is preferable that the inorganic fine particles are small-sized as far as possible in the dispersion medium. The mass-average diameter is from 1 to 200 nm, preferably from 5 to 150 nm, still preferably from 10 to 100 nm and particularly preferably from 10 to 80 nm.

To lessen the diameter of the inorganic fine particles to 200 nm or less, a high refractive index layer and a medium refractive index layer can be formed without worsening the transparency.

(Method of Forming High (Medium) Refractive Index Layer)

The high refractive index layer and the medium refractive index layer to be used in the invention are formed preferably as follows. Namely, after dispersing the inorganic fine particles in the dispersion medium as discussed above, a binder precursor required in matrix formation (for example, a polyfunctional monomer or a polyfunctional oligomer hardening under ionizing radiation as will be described hereinafter), a photo polymerization initiator and so on are added to the dispersion to give a coating composition for forming high refractive index layer and medium refractive index layer. Then this coating composition for forming high refractive index layer and medium refractive index layer is applied to a transparent support and hardened by the crosslinkage or polymerization of the ionizing radiation-hardening compound (for example, a polyfunctional monomer or a polyfunctional oligomer).

It is also preferable that the binder in the high refractive index layer and the medium refractive index layer undergoes crosslinkage or polymerization with the dispersing agent simultaneously with the application or thereafter. As the binder in the high refractive index layer and the medium refractive index layer, use is preferably made of a binder illustrated with respect to the hard coat layer. It is also preferable to select an appropriate polymerization initiator depending on the binder type.

In the binder in the high refractive index layer and the medium refractive index layer thus formed, the preferable dispersing agent as described above undergoes crosslinkage or polymerization with the ionizing radiation-hardening (curing) polyfunctional monomer or polyfunctional oligomer and thus the anionic group of the dispersing agent is incorporated into the binder. In the binder in the high refractive index layer and the medium refractive index layer, moreover, the anionic group has a function of sustaining the inorganic fine particles in the dispersed state. The crosslinked or polymerized structure imparts a film-forming ability to the binder so as to improve the mechanical strength, chemical resistance and weatherability of the high refractive index layer and the medium refractive index layer.

Functional groups in the ionizing radiation-hardening polyfunctional monomer or polyfunctional oligomer for forming the binder as described above, those polymerizable due to heat, electron beams or radiation are preferable and photo polymerizable functional groups are still preferable.

Examples of the photo polymerizable functional groups include unsaturated polymerizable functional groups such as (meth)acryloyl group, vinyl group, styryl group and allyl group. Among all, (meth)acryloyl group is preferred.

Specific examples of the photo polymerizable polyfunctional monomer having a photo polymerizable functional group are as follows:

(meth)acrylic acid diesters such as neopentyl glycol acrylate, 1,6-hexanediol (meth)acrylate and propylene glycol di(meth)acrylate;

polyoxyethylene glycol (meth)acrylic acid diesters such as triethylene glycol di(meth)acrylate, dipropylene glycol di(meth)acrylate, polyethylene glycol di(meth)acrylate and polypropylene glycol di(meth)acrylate;

polyhydric alcohol (meth)acrylic acid diesters such as pentaerythritol di(meth)acrylate; and

ethylene oxide or propylene oxide adduct (meth)acrylic acid diesters such as 2,2-bis{4-(acryloxy diethoxy)phenyl}propane and 2-2-bis{4-(acryloxy propoxy)phenyl}propane.

Also, use may be preferably made of epoxy (meth)acrylates, urethane (meth)acrylates and polyester (meth)acrylates as the photo polymerizable polyfunctional monomer.

Among all, esters of polyhydric alcohols with (meth)acrylic acid are preferred. Polyfunctional monomers having three or more (meth)acryloyl groups per molecule are still preferred. Specific examples thereof include trimethylolpropane tri(meth)acrylate, trimethylolethane tri(meth)acrylate, 1,2,4-cyclohexane tetra(meth)acrylate, pentaglycerlol triacrylate, pentaerythritol tetra(meth)acrylate, pentaerythritol tri(meth)acrylate, dipentaerythritol triacrylate, dipentaerythritol pentaacrylate, dipentaerythritol tetra(meth)acrylate, dipentaerythritol hexa(meth)acrylate, tripentaerythritol triacrylate, tripentaerythritol hexatriacrylate and so on.

Use may be also made of two or more types of polyfunctional monomers together.

In polymerizing the photo polymerizable polyfunctional monomer, it is preferable to use a photo polymerization initiator. As the photo polymerization initiator, a photo radical polymerization initiator and a photo cation polymerization initiator are preferable and a photo radical polymerization initiator is still preferable.

As the photo radical polymerization initiator, use can be made of acetophenones, benzophenones, Michler's benzoyl benzoate, α-amyloxime ester, tetramethyl thiuram sulfide and thioxanthons.

Examples of commercially available photo radical polymerization initiators include KAYACURES (DETX-S, BP-100, BDMK, CTX, BMS, 2-EAQ, ABQ, CPTX, EPD, ITX, QTX, BTC, MCA and so on, manufactured by NIPPON KAYAKU Co., Ltd.), IRGACURES (651, 184, 500, 907, 369, 1173, 2959, 4265, 4263 and so on, manufactured by Ciba Specialty Chemicals) and Es a cures (KIP100F, KB1, EB3, BP, X33, KT046, KT37, KIP150 and TZT, manufactured by Sartomer Co.).

It is particularly preferable to use a photo radical polymerization initiator of the photo cleavage type. Photo radical polymerization initiators of the photo cleavage are reported in Saishin UV Koka Gijutsu, (p. 159, publisher: Kazuhiro Takausu, publishing office: GIJUTSU KYOKAI K. K., 1991).

As preferable examples of commercially available photo radical polymerization initiators of the photo cleavage type, IRGACURES (651, 184, 907) (manufactured by Ciba Specialty Chemicals) may be cited.

The photo polymerization initiator is used preferably in an amount of from 0.1 to 15 parts by mass, still preferably from 1 to 10 parts by mass, per 100 parts by mass of the polyfunctional monomer.

In addition to the photo polymerization initiator, use may be made of a photo sensitizer. Specific examples of the photo sensitizer include n-butylamine, triethylamine, tri-n-butylphosphine, Micheler's ketone and thioxanthone.

Examples of commercially available photo sensitizers include KAYACURES (DMBI and EPA) manufactured by NIPPON KAYAKU Co., Ltd. and so on.

It is preferable to perform the photo polymerization by irradiating ultraviolet light after applying and drying the high refractive index layer.

To construct an antireflective film by forming the low refractive index layer on the high refractive index layer, the refractive index of the high refractive index layer ranges preferably from 1.55 to 2.40, still preferably from 1.60 to 2.20, still preferably from 1.65 to 2.10 and most desirably from 1.80 to 2.00.

In the case of a three-layered film interference type having the medium refractive index layer and the low refractive index layer formed on the high refractive index layer, the refractive index of the high refractive index layer ranges preferably from 1.65 to 2.40, still preferably from 1.70 to 2.20 and still preferably from 1.80 to 2.10. The refractive index of the medium refractive index layer is controlled to a level between the refractive index of the low refractive index layer and the refractive index of the high refractive index layer. The refractive index of the medium refractive index layer preferably ranges from 1.55 to 1.80, still preferably from 1.58 to 2.00 and still preferably from 1.60 to 1.80. It is also preferable that the high refractive index layer and the medium refractive index layer have each a haze of 3% or less.

In addition to the above-described components (i.e., the inorganic fine particles, the polymerization initiator, the photo sensitizer, etc.), the high (medium) refractive index layer may contain a resin, a surfactant, an antistatic agent, a coupling agent, a thickener, a coloration inhibitor, a coloring agent (a pigment or a dye), a defoaming agent, a leveling agent, a flame retardant agent, an ultraviolet absorber, an infrared absorber, a tackifier, a polymerization inhibitor, an antioxidant, a surface-improver, electrically conductive metal fine particles and so on.

(Transparent Support)

The antireflective film according to the invention has a transparent support on which individual layers are formed. The light transmittance of the transparent support is preferably 80% or more, still preferably 86% or more. The haze of the transparent support is preferably 2.0% or less, still preferably 1.0% or less. The refractive index of the transparent support preferably ranges from 1.4 to 1.7.

As the material of the transparent support, a plastic film is preferable to a glass plate. Examples of the plastic film material include cellulose ester, polyamide, polycarbonate, polyesters (for example, polyethylene terephthalate, polyethylene naphthalate, poly-1,4-cyclohexane dimethylene terephthalate, polyethylene-1,2-diphenoxyehtane-4,4′-dicarboxylate and polybutylene terephthalate), polystyrenes (for example, syndiotactic polystyrene), polyolefins (for example, polypropylene, polyethylene and polymethylpentene), polysulfone, polyether sulfone, polyarylate, polyether imide, polymethyl methacrylate and polyether ketone. Among all, cellulose ester, polycarbonate, polyethylene terephthalate and polyethylene naphthalate are preferred.

In the case of using in a liquid display unit, a cellulose acylate film is particularly preferable. Cellulose acylate is produced by esterifying cellulose. As the cellulose before the esterification, use may be made of refined linter, kenaf or pulp.

In the invention, it is preferable that cellulose acylate, which means a fatty acid ester of cellulose, is a lower fatty acid ester and a cellulose fatty acid ester film is still preferable.

The term “lower fatty acid” means a fatty acid having not more than 6 carbon atoms. A cellulose acylate having from 2 to 4 carbon atoms is preferable and cellulose acetate is particularly preferable. It is also preferable to use a mixed fatty acid ester such as cellulose acetate propionate or cellulose acetate butyrate.

The viscosity-average degree of polymerization (DP) of the cellulose acylate is preferably 250 or more. It is also preferable that the cellulose acylate has a narrow molecular weight distribution indicated by Mw/Mn in gel permeation chromatography (Mw: mass-average molecular weight, Mn: number-average molecular weight). More specifically speaking, Mw/Mn preferably ranges from 1.0 to 5.0, still preferably from 1.0 to 3.0 and particularly preferably from 1.0 to 2.0.

As the transparent support in the invention, use is preferably made of a cellulose acylate having a degree of acetification of from 55.0 to 62.5%, still preferably form 57.0 to 62.0% and particularly preferably form 59.0 to 61.5%. The degree of acetification, which means the amount of acetate bonded per unit mass of cellulose, can be determined by measuring the degree of acylation and calculating in accordance with ASTM:D-817-91 (Test Method for Cellulose Acylate, etc.).

In cellulose acylate, it is generally observed that hydroxyl substitution does not occur uniformly at the 2-, 3- and 6-positions of cellulose but the degree of substitution at the 6-position is lower. In the cellulose acylate to be used in the invention, it is favorable that the degree of substitution at the 6-position is comparable to or higher than those at the 2- and 3-positions.

The ratio of the degree of substitution at the 6-position to the total degree of substitution at the 2-, 3- and 6-positions preferably ranges from 30 to 40%, still preferably from 31 to 40% and most desirably from 32 to 40%.

To control various properties such as mechanical properties (membrane strength, curling, dimensional stability, slipperiness and so on) and durability (resistance to moist heat, weatherability and so on), the transparent support may contain various additives. Examples of the additives include plasticizers (for example, phosphates, phthalates and polyol fatty acid esters), ultraviolet blocking agents (for example, hydroxybenzophenone compounds, benzotriazole compounds, salicylate compounds and cyanoacrylate compounds), degradation inhibitors (for example, antioxidants, peroxide-decomposing agents, radical inhibitors, metal inactivators, acid-capturing agents and amines), fine particles (for example, SiO₂, Al₂O₃, TiO₂, BaO₄, CaCO₃, MgCO₃, talc and kaolin), releasing agents, antistatic agents and infrared absorbers.

More specifically, it is preferable to use materials which are described in detail in Japan Institute of Invention and Innovation Journal of Technical Disclosure No. 2001-1745 (2001 Mar. 15, Japan Institute of Invention and Innovation), p. 17 to 22.

Such additives are employed preferably in an amount of from 0.01 to 20% by mass, still preferably from 0.05 to 10% by mass based on the transparent support.

The transparent support may be surface-treated.

Examples of the surface treatment include chemical treatments, mechanical treatments, corona discharge treatment, flame treatment, ultraviolet irradiation treatment, high-frequency wave treatment, glow discharge treatment, active plasma treatment, laser treatment, mixed acid-treatment and ozone oxidation treatment. More specifically speaking, use may be made of treatments reported in Japan Institute of Invention and Innovation Journal of Technical Disclosure No. 2001-1745 (2001 Mar. 15, Japan Institute of Invention and Imiovation), p. 30 to 31 and JP-A-2001-9973.

The glow discharge treatment, the ultraviolet irradiation treatment, the corona discharge treatment and the flame treatment are preferred and the glow discharge treatment and the ultraviolet treatment are still preferred.

[Method of Forming Antireflective Film]

Next, a method of forming the antireflective film according to the invention will be illustrated.

Individual layers of the antireflective film can be formed by coating with the use of dip coating method, air knife coating method, curtain coating method, roller coating method, die coating method, wire bar coating method or gravure coating method. Among these coating methods, the gravure coating method is favorable since a coating solution in a small coating amount (for example, one for forming each layer of the antireflective film) can be applied to give a uniform membrane thickness thereby. In the gravure coating method, microgravure method, whereby a high membrane thickness uniformity can be established, is particularly preferable.

It is also possible that, by using the die coating method, a coating solution in a small coating amount can be applied at a high membrane thickness uniformity. Because of employing the pre-measuring system, moreover, the membrane thickness can be relatively easily controlled in the die coating method and the solvent scarcely evaporates in the course of the coating, which makes this method favorable. It is also possible to simultaneously form two or more layers by coating. Methods for the simultaneous coating are described in U.S. Pat. No. 2,761,791, U.S. Pat. No. 2,941,898, U.S. Pat. No. 3,508,947, U.S. Pat. No. 3,526,528 and KOTINGUKOGAKU, Yuji Harasaki, p. 253, Asakura Shoten (1973).

The layers are formed in the following order. First, a coating solution for forming hard coat layer is applied on the transparent support followed by heating and drying. Then, the monomer for forming the hard coat layer is polymerized and hardened by photo irradiation or heating, thereby forming the hard coat layer. Subsequently, the coating solutions for forming medium refractive index layer and high refractive index layer or low refractive index layer are applied on hard coat layer and photo irradiated or heated to thereby form the medium refractive index layer and the high refractive index layer of the low refractive index layer. In the formation of the antireflective film according to the invention, it is preferable that hardening by photo irradiation (so-called ionizing irradiation) and hardening by heating are used together in forming a single layer (in particular, the low refractive index layer).

Concerning the hardening by photo irradiation and the hardening by heating, the hardening by photo irradiation may be followed by the hardening by heating as reported in WO 03/27189A, etc. However, these hardening (curing) treatments may be carried out in any order and it is also possible to perform each hardening treatment twice or more. It is particularly preferable to perform the hardening by photo irradiation followed by the hardening by heating.

In the formation of individual layers of the antireflective film according to the invention, it is preferable to perform the crosslinkage or polymerization of the ionizing radiation-hardening compound in an atmosphere with an oxygen concentration of 10% by volume or less. By forming individual layers in an atmosphere with an oxygen concentration of 10% by volume or less, the mechanical strength, chemical resistance and weatherability of each layer can be improved and, furthermore, the adhesiveness of the high refractive index layer to the layer adjacent to the high refractive index layer can be improved.

It is preferable to form individual layers by performing the crosslinkage or polymerization of the ionizing radiation-hardening compound in an atmosphere with an oxygen concentration of 6% by volume or less, still preferably 4% by volume or less, particularly preferably 2% by volume or less and most desirably 1% by volume or less.

[Polarizing Plate]

The polarizing plate according to the invention has the antireflective film according to the invention as described above as at least one of two protective films in the polarizing layer. By using the antireflective film according to the invention as the outermost layer, it is possible to obtain a polarizing plate which is free from the reflection of outside light and the like and excellent in scuff proofness and stain proofness. In the polarizing plate according to the invention, the antireflective film can also serve as a protective film, thereby reducing the production cost.

[Image Display Unit]

The image display unit according to the invention is characterized by having at least one of the antireflective membrane, antireflective film and polarizing plate (a polarizing plate having an antireflective function) as described above in the image display face. The antireflective membrane, antireflective film and polarizing plate according to the invention are applicable to image display units such as a liquid crystal display unit (LCD) and an organic EL display. It is preferable to apply the image display unit according to the invention to transmission type, reflection type or semi-transmission type liquid crystal display units of TN, STN, IPS, VA and OCB modes, as will be described hereinafter in greater detail.

As the liquid crystal display unit, use may be made of any publicly known one. Examples thereof include those described in Hanshagata Kara LCD Sogo Gijutsu (supervised by Tatsuo Uchida, CMC K. K., 1999), Furatto Paneru Disupurei no Shintenkai (Research Division, Toray Research Center, 1996), Ekisho Kanren Shijo no Genjo to Shorai Tenbo, Vols. I and II (Fuji Chimera Research Institute, 2003) and so on.

More specifically speaking, the image display unit according to the invention is preferably usable in the transmission type, reflection type or semi-transmission type liquid crystal display units of twisted nematic (TN), (super twisted nematic (STN), vertical alignment (VA), in plane switching (IPS) and optically compensated bend cell (OCB) modes.

The polarizing plate according to the invention has a clear contrast and a wide viewing angle, can be free from color hue change and the reflection of outside light and shows a high durability, even in the case of being used in an image display unit having a 17 inch image display or larger, which makes it favorable.

[TN Mode Liquid Crystal Display Unit]

TN mode liquid crystal display units have been most frequently employed as color TFT liquid crystal display units and reported in a large number of documents. Concerning the alignment state in a liquid crystal cell at the black display of the T mode, rod-like liquid crystal molecules upstand at the center of the cell while rod-like liquid crystal molecules lie down around the cell substrate.

[OCB Mode Liquid Crystal Display Unit]

A liquid crystal cell of the OCB mode is a liquid crystal cell of the bend alignment mode in which rod-like molecules are aligned in the opposite directions (i.e., symmetrically) in the upper and lower parts of the liquid crystal cell. In liquid crystal display units provided with a liquid crystal cell of the bend alignment mode disclosed by U.S. Pat. No. 4,583,825 and U.S. Pat. No. 5,410,422, symmetric alignments are observed in the upper and lower parts of the liquid crystal cell. Thus, the liquid crystal cell of the bend alignment mode has a self-optically compensatory function. Accordingly, such this liquid crystal mode is also called the OCB (Optically Compensatory Bend) liquid crystal mode.

Concerning the alignment state in a liquid crystal cell at the black display of the OCB mode, rod-like liquid crystal molecules upstand at the center of the cell while rod-like liquid crystal molecules lie down around the cell substrate, similar to the TN mode.

[VA Mode Liquid Crystal Display Unit]

In a liquid crystal cell of the VA mode, rod-like liquid crystal molecules are substantially vertically aligned while voltage is not applied.

Liquid crystal cells of the VA mode include: (1) a liquid crystal cell of VA mode in a narrow sense, in which rod-like liquid crystal molecules are essentially vertically aligned while voltage is not applied, and the molecules are essentially horizontally aligned while voltage is applied (JP-A-2-176625); (2) a liquid crystal cell of MVA mode, in which the VA mode is modified to be multi-domain type so as to enlarge the viewing angle (described in SID97, Digest of tech. Papers, 28 (1997), 845); (3) a liquid crystal cell of n-ASM mode, in which rod-like liquid crystal molecules are essentially vertically aligned while voltage is not applied, and the molecules are essentially oriented in twisted multi-domain alignment while voltage is applied (described in Nippon Ekisho Toronkai [Liquid crystal forum of Japan], Digest of tech. Papers (1998), 58-59); and (4) a liquid crystal cell of SURVAIVAL mode (published in LCD international 98).

[IPS Mode Liquid Crystal Display Unit]

In a liquid crystal cell of the IPS mode, in which liquid crystal molecules are continuously rotated in a horizontal plane to the substrate, the liquid crystal molecules are aligned at a some angle to the longitudinal direction of the electrode when no electrical field is applied. Upon electric field application, the liquid crystal molecules turn to the direction of the electrical field. Light transmittance can be varied by locating a polarizing plate holding the liquid crystal at a definite angle. As the liquid crystal molecules, use is made of nematic liquid crystals having a positive dielectric anisotropy Δε. The thickness (gap) of the liquid crystal layer is more than 2.8 μm but less than 4.5 μm. Thus, transmission properties almost independent from wavelength in the visual light scope can be obtained in the case where retardation Δnd is more than 0.25 μm but less than 0.32 μm. By appropriately combining polarizing plates, the maximum transmittance can be achieved when the liquid crystal molecules rotate at 45° from the rubbing direction toward the electrical field direction. The thickness (gap) of the liquid crystal layer is controlled by using polymer beads. Needless to say, a similar gap can be obtained with the use of glass beads, fibers or a spacer made of resin columns. The liquid crystal molecules are not specifically restricted, so long as they are nematic liquid crystals. A unit with a larger dielectric anisotropy Δε can be driven at the lower voltage. A smaller refractive index anisotropy Δn can give a larger liquid crystal thickness (gap), thereby shortening the time required for the liquid crystal inclusion and lessening gap scattering.

[Other Liquid Crystal Modes]

In the case of liquid crystal display units of the ECB mode and the STN mode, the polarizing plate according to the invention can be employed based on the same idea as discussed above.

[Display Unit]

A liquid crystal display unit can be constructed in accordance with the manner commonly employed. Namely, a liquid crystal display unit is generally constructed by appropriately combining constituting parts such as a liquid crystal cell, an optical film and, if needed, an illumination system and integrating a driving circuit thereinto. In the invention, a display unit may be constructed in a conventional manner without specific restriction but using the liquid crystal display device according to the invention.

In constructing a liquid crystal display unit, appropriate parts (for example, a prism array, a lens array sheet, a light diffusion plate, a light introduction plate, a back light and so on) can be provided at appropriate sites to give one or more layers. By combining with a λ/4 plate, furthermore, it is possible to provide a polarizing plate for reflective liquid crystals or a surface-protective plate for organic EL displays for lessening reflection light from the surface and the inside.

### EXAMPLES

Now, the invention will be illustrated in greater detail by reference to the following EXAMPLES. However, it is to be understood that the invention is not construed as being restricted to these EXAMPLES. Unless otherwise noted, each “parts” and “%” are based on mass.

### Synthesis Example 1

### Synthesis of Perfluoroolefin Copolymer (1)

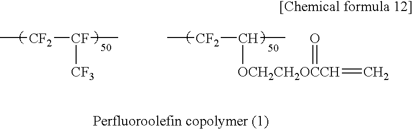 [0246] (50:50 stands for the molar ratio)

Into a stainless autoclave (capacity 100 ml) equipped with a stirrer were added 40 ml of ethyl acetate, 14.7 g of hydroxyethyl vinyl ether and 0.55 g of dilauroyl peroxide. After degassing, the system was purged with nitrogen. After further adding 25 g of hexafluoropropylene (HFP) into the autoclave, the mixture was heated to 65° C. When the temperature in the autoclave attained 65° C., the pressure was 0.53 MPa (5.4 kg/cm²). While maintaining at this temperature, the reaction was continued for 8 hours. When the pressure attained 0.31 MPa (3.2 kg/cm²), heating was stopped and the mixture was cooled by allowing to stand. When the internal temperature was lowered to room temperature, the unreacted monomer was eliminated and the autoclave was opened. Then the liquid reaction mixture was taken out and poured into hexane in large excess. Then the solvent was removed by decantation and the precipitated polymer was taken out. Further, this polymer was dissolved in a small amount of ethyl acetate and re-precipitated from hexane twice to thereby completely eliminate the remaining monomer. After drying, 28 g of the polymer was obtained. Then 20 g of this polymer was dissolved in 100 ml of N,N-dimethylacetamide. After dropping 11.4 g of acrylic acid chloride under ice-cooling, the mixture was stirred at room temperature for 10 hours. Then ethyl acetate was added to the liquid reaction mixture followed by washing with water. The organic layer was extracted and concentrated. The polymer thus obtained was re-precipitated from hexane to thereby give 19 g of a fluorine-containing copolymer (1). The refractive index of the obtained polymer was 1.421.

(Preparation of Sol Solution a)

Into a reactor equipped with a stirrer and a reflux condenser were added 120 parts of methyl ethyl ketone, 100 parts of acryloyloxypropyltrimethoxysilane (KBM-5103, (manufactured by SHIN-ETSU CHEMICAL Co.) and 3 parts of diisopropoxyaluminum ethylacetoacetate (CHELOPE EP-12 manufactured by Hope Chemical Co., Ltd.). After mixing, 30 parts of ion-exchanged water was added thereto and the resultant mixture was reacted at 60° C. for 4 hours. Then it was cooled to room temperature to give a sol solution a which had a mass-average molecular weight of 1600 and in which the content of components having molecular weight of 1000 to 20000 in oligomer components amounted to 100%. When analyzed by gas chromatography, it was found out that no starting acryloxypropyltrimethoxysilane remained therein.

| | |
|---|---|
| (Preparation of coating solution A for forming hard | |
| coat layer) | |
| DESOLITE Z7401 | 102 parts by mass |
| (zirconia fine particle (diameter: 20 nm)-containing | |
| hard coat solution: manufactured by JSR) | |
| DPHA | 29 parts by mass |
| (UV-hardening resin: manufactured by | |
| NIPPON KAYAKU Co., Ltd.) | |
| KBM-5103 | 10 parts by mass |
| (silane coupling agent: manufactured by | |
| SHIN-ETSU CHEMICAL Co.) | |
| KE-P150 | 8.9 parts by mass |
| (1.5 μm silica particles: manufactured by | |
| NIPPON SHOKUBAI) | |
| MXS-300 | 3.4 parts by mass |
| (3 μm crosslinked PMMA particles: manufactured | |
| by SOKEN KAGAKU K.K.) | |
| MEK (methyl ethyl ketone) | 29 parts by mass |
| MIBK (methyl isobutyl ketone) | 13 parts by mass |
| (Preparation of coating solution B for foaming hard | |
| coat layer) | |
| trimethylolpropane triacrylate | 740.0 parts by mass |
| (TMPTA: manufactured by | |
| NIPPON KAYAKU Co., Ltd.) | |
| poly(glycidyl methacrylate) | 280.0 parts by mass |
| (mass-average molecular weight 15000) | |
| methyl ethyl ketone | 730.0 parts by mass |
| cyclohexanone | 500.0 parts by mass |
| photo polymerization initiator | 50.0 parts by mass |
| (IRGACURE 184: manufactured by | |
| Ciba Specialty Chemicals) | |
| Cationic photopolymerization initiator | 25.0 parts by mass |

(LOADSIL 2074) The above-described coating solutions A and B were passed through polypropylene filters of a pore size of 30 μm and a pore size of 0.4 μm respectively to give coating solutions for hard coat later.
(Preparation Of Titanium Dioxide Fine Particle Dispersion)

As titanium dioxide fine particles, use was made of titanium dioxide fine particles containing cobalt and having been surface-treated with the use of aluminum hydroxide and zirconium hydroxide (MPT-129, manufactured by ISHIHARA SANGYO KAISHA, Ltd., TiO₂:CO₃O₄:Al₂O₃:ZrO₂=90.5:3.0:4.0:0.5 by mass).

257.1 parts by mass of these particles were mixed with 41.1 parts by mass of the following dispersant and 701.8 parts by mass of cyclohexanone and dispersed with Dynomil to thereby give a titanium dioxide dispersion having a mass-average diameter of 70 nm.

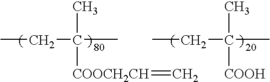

[Preparation of coating solution A for medium refractive index layer]

| | |
|---|---|
| titanium dioxide dispersion | 99.1 parts by mass |
| DPHA | 68.0 parts by mass |
| (manufactured by NIPPON KAYAKU Co., Ltd.) | |
| photo polymerization initiator | 3.6 parts by mass |
| (IRGACURE 907: manufactured by Ciba | |
| Specialty Chemicals) | |
| photo sensitizer | 1.2 parts by mass |
| (KAYACURE DETX-S: manufactured by | |
| NIPPON KAYAKU Co., Ltd.) | |
| methyl ethyl ketone | 279.6 parts by mass |
| cyclohexanone | 1049.0 parts by mass |

After thoroughly stirring, the mixture was passed through a polypropylene filter having a pore size of 0.4 μm.

[Preparation of coating solution A for high refractive index layer]

| | |
|---|---|
| titanium dioxide dispersion | 469.8 parts by mass |
| DPHA | 40.0 parts by mass |
| (manufactured by | |
| NIPPON KAYAKU Co., Ltd.) | |
| photo polymerization initiator | 3.3 parts by mass |
| (IRGACURE 907: manufactured by | |
| Ciba Specialty Chemicals) | |
| photo sensitizer | 1.1 parts by mass |
| (KAYACURE DETX-S: manufactured by NIPPON | |
| KAYAKU Co., Ltd.) | |
| methyl ethyl ketone | 526.2 parts by mass |
| cyclohexanone | 459.6 parts by mass |

After thoroughly stirring, the mixture was passed through a polypropylene filter having a pore size of 0.4 μm.

[Preparation of coating solution A for low refractive index layer]

| | |
|---|---|
| JTA113 | 933.3 parts by mass |
| MEK-ST-L (30.0%) | 130 parts by mass |
| sol solution a | 12.65 parts by mass |
| cyclohexanone | 157 parts by mass |
| MEK | 434 parts by mass |

[Preparation of coating solution B for low refractive index layer]

| | |
|---|---|
| JTA113 | 933.3 parts by mass |
| hollow silica A (20.0%) | 195 parts by mass |
| sol solution a | 12.65 parts by mass |
| cyclohexanone | 157 parts by mass |
| MEK | 369 parts by mass |

[Preparation of coating solution C for low refractive index layer]

| | |
|---|---|
| JTAL113 | 783 parts by mass |
| hollow silica A (20.0%) | 195 parts by mass |
| MEK-ST | 30 parts by mass |
| sol solution a | 12.65 parts by mass |
| cyclohexanone | 157 parts by mass |
| MEK | 489 parts by mass |

[Preparation of coating solution D for low refractive index layer]

| | |
|---|---|
| JTA113 | 783 parts by mass |
| hollow silica A (20.0%) | 195 parts by mass |
| MEK-ST-L | 30 parts by mass |
| sol solution a | 12.65 parts by mass |
| cyclohexanone | 157 parts by mass |
| MEK | 489 parts by mass |

[Preparation of coating solution E for low refractive index layer]

| | |
|---|---|
| JTA113 | 866 parts by mass |
| hollow silica A (20.0%) | 195 parts by mass |
| MEK-ST-L | 30 parts by mass |
| cyclohexanone | 157 parts by mass |
| MEK | 419 parts by mass |

[Preparation of coating solution F for low refractive index layer]

| | |
|---|---|
| JTA113 | 783 parts by mass |
| hollow silica B (20.0%) | 195 parts by mass |
| MEK-ST-L | 30 parts by mass |
| sol solution a | 12.65 parts by mass |
| cyclohexanone | 157 parts by mass |
| MEK | 489 parts by mass |

[Preparation of coating solution G for low refractive index layer]

| | |
|---|---|
| JTA113 | 783 parts by mass |
| hollow silica A (20.0%) | 195 parts by mass |
| IPA-ST-ZL | 30 parts by mass |
| sol solution a | 12.65 parts by mass |
| cyclohexanone | 157 parts by mass |
| MEK | 489 parts by mass |

[Preparation of coating solution H for low refractive index layer]

| | |
|---|---|
| JTA113 | 783 parts by mass |
| hollow silica C (20.0%) | 195 parts by mass |
| IPA-ST-ZL | 30 parts by mass |
| sol solution a | 12.65 parts by mass |
| cyclahexanone | 157 parts by mass |
| MEK | 489 parts by mass |

[Preparation of coating solution I for low refractive index layer]

| | |
|---|---|
| perfluoroolefin copolymer (1) | 47 parts by mass |
| hollow silica A (20.0%) | 195 parts by mass |
| MEK-ST-L | 30 parts by mass |
| X22-164C | 1.4 parts by mass |
| sol solution a | 12.65 parts by mass |
| IRGACURE 907 | 2.4 parts by mass |
| cyclohexanone | 156 parts by mass |
| MEK | 1223 parts by mass |

After mixing, the above solutions were passed through a polypropylene filter having a pore size of 1 μm to give individual coating solutions for low refractive index layer.

The compounds employed above are as follows.
IRGACURE 184: polymerization initiator (manufactured by Ciba Specialty Chemicals)
SX-350: average particle diameter 3.5 μm, crosslinked polystyrene particles (refractive index 1.60, manufactured by SOKEN KAGAKU K. K., 30% dispersion in toluene. Used after dispersing in a polytron dispersion device at 10000 rpm for 20 min.)
KBM-5103: silane coupling agent (manufactured by SHIN-ETSU CHEMICAL Co.)
JTA 113: heat crosslinkable fluoropolymer (refractive index 1.44, solid content 6%; manufactured by JSR) “OPSTAR JTA113®”
DPHA: dipentaerythritol pentaacrylate/dipentaerythritol hexaacrylate mixture (manufactured by NIPPON KAYAKU Co., Ltd.)
MEK-ST: silica sol (silica, average particle diameter 15 nm, solid content 30%, manufactured by NISSAN CHEMICAL INDUSTRIES, Ltd.)
MEK-ST-L: silica sol (silica, different from MEK-ST in particle diameter, average particle diameter 45 nm, solid content 30%, manufactured by NISSAN CHEMICAL INDUSTRIES, Ltd.)
hollow silica A: KBM-5103 surface-modified hollow silica sol (surface modification ratio to hollow silica (prepared in accordance with Preparation Example 4 in JP-A-2002-79616; average particle diameter about 40 nm, shell thickness about 7 nm, refractive index of silica particles 1.31)) 30% by mass, solid content 20.0%)
hollow silica B: surface-unmodified hollow silica sol (prepared in accordance with Preparation Example 4 in JP-A-2002-79616; average particle diameter about 40 nm, shell thickness about 7 nm, refractive index of silica particles 1.31), solid content 20.0%)
hollow silica C: KBM-5103 surface-modified, large-sized hollow silica sol (surface modification ratio to hollow silica (prepared in accordance with Preparation Example 4 in JP-A-2002-79616; average particle diameter about 100 nm, shell thickness about 17 nm, refractive index of silica particles 1.31)) 30% by mass, solid content 20.0%)
IPA-ST-ZL: silica sol (average particle diameter 120 nm, solid content 30%, manufactured by NISSAN CHEMICAL INDUSTRIES, Ltd.)
X22-164C: reactive silicone (manufactured by SHIN-ETSU CHEMICAL Co.)
IRGACURE 907: polymerization initiator (manufactured by Ciba Specialty Chemicals)

### Example 1

(1-1) Formation of Hard Coat Layer A

As a support, a triacetyl cellulose film (TD80U, manufactured by FUJI PHOTOFILM Co., Ltd.) was unwound in a rolled state. Then the coating solution A for hard coat layer as described above was directly applied by using a microgravure roll (diameter: 50 mm) having a gravure pattern of a line density of 135 lines/in. and a depth of 60 μM and a doctor blade at a conveying speed of 10 m/min. After drying at 60° C. for 150 seconds, the coating layer was hardened by irradiating under nitrogen-purge with ultraviolet light by using a 160 W/cm air-cool metal halide lamp (manufactured by EYEGRAPHICS Co., Ltd.) at an illuminance of 400 mW/cm² and an irradiation dose of 250 mJ/cm². Thus a hard coat layer was formed and wound. The gravure roll rotational speed was controlled so as to give a hard coat layer thickness of 3.6 μm after the hardening.

(1-2) Formation of Hard Coat Layer B

As a support, a triacetyl cellulose film (TD80UF, manufactured by FUJI PHOTOFILM Co., Ltd.) was unwound in a rolled state. Then the coating solution B for hard coat layer as described above was directly applied by using a microgravure roll (diameter: 50 mm) having a gravure pattern of a line density of 180 lines/in. and a depth of 40 μm and a doctor blade at a conveying speed of 30 m/min. After drying at 60° C. for 150 seconds, the coating layer was hardened by irradiating under nitrogen-purge with ultraviolet light by using a 160 W/cm air-cool metal halide lamp (manufactured by EYEGRAPHICS Co., Ltd.) at an illuminance of 400 mW/cm² and an irradiation dose of 300 mJ/cm². Thus a hard coat layer was formed and wound. The gravure roll rotational speed was controlled so as to give a hard coat layer thickness of 8 μm after the hardening.

(2) Formation of Medium Refractive Index Layer

The triacetyl cellulose film (TD80UF, manufactured by FUJI PHOTOFILM Co., Ltd.) having the hard coat layer B thus formed thereon was unwound again. Then, the coating solution for medium refractive index layer was applied by using a microgravure roll (diameter: 50 mm) having a gravure pattern of a line density of 180 lines/in. and a depth of 40 μm and a doctor blade. After drying at 90° C. for 30 seconds, the coating layer was hardened by irradiating, under nitrogen-purge while controlling the oxygen concentration to 1.0% by volume or less, with ultraviolet light by using a 180 W/cm air-cool metal halide lamp (manufactured by EYEGRAPHICS Co., Ltd.) at an illuminance of 400 mW/cm² and an irradiation dose of 400 mJ/cm². Thus a medium refractive index layer was formed and wound, while controlling the gravure roll rotational speed so as to give a layer thickness of 67 nm after the hardening.

(3) Formation of High Refractive Index Layer

The triacetyl cellulose film (TD-80UF, manufactured by FUJI PHOTOFILM Co., Ltd.) having the medium refractive index layer thus formed thereon was unwound again. Then, the coating solution for high refractive index layer was applied by using a microgravure roll (diameter: 50 mm) having a gravure pattern of a line density of 180 lines/in. and a depth of 40 and a doctor blade. After drying at 90° C. for 30 seconds, the coating layer was hardened by irradiating, under nitrogen-purge while controlling the oxygen concentration to 1.0% by volume or less, with ultraviolet light by using a 240 W/cm air-cool metal halide lamp (manufactured by EYEGRAPHICS Co., Ltd.) at an illuminance of 600 mW/cm² and an irradiation dose of 400 mJ/cm². Thus a high refractive index layer was formed and wound, while controlling the gravure roll rotational speed so as to give a layer thickness of 107 nm after the hardening.

(4-1) Formation of Low Refractive Index Layer “Coating-Hardening (Curing) System A”

The triacetyl cellulose film having the hard coat layer or the high refractive index layer thus formed thereon was unwound again. Then, the coating solution for low refractive index layer as described above was applied by using a microgravure roll (diameter: 50 mm) having a gravure pattern of a line density of 180 lines/in. and a depth of 40 μM and a doctor blade at a conveying speed of 15 m/min. After drying at 120° C. for 150 seconds, the coating layer was hardened by irradiating, under nitrogen-purge, with ultraviolet light by using a 240 W/cm air-cool metal halide lamp (manufactured by EYEGRAPHICS Co., Ltd.) at an illuminance of 400 mW/cm² and an irradiation dose of 900 mJ/cm². Thus a low refractive index layer was formed and wound, while controlling the gravure roll rotational speed so as to give a layer thickness of 100 nm after the hardening.

(4-2) Formation of Low Refractive Index Layer “Coating-Hardening System B”

The triacetyl cellulose film having the hard coat layer or the high refractive index layer thus formed thereon was unwound again. Then, the coating solution for low refractive index layer as described above was applied by using a microgravure roll (diameter: 50 mm) having a gravure pattern of a line density of 180 lines/in. and a depth of 40 μM and a doctor blade at a conveying speed of 15 m/min. After pre-drying at 120° C. for 150 seconds, drying was carried out at 90° C. for 50 hours. Thus a low refractive index layer was formed and wound, while controlling the gravure roll rotational speed so as to give a layer thickness of 100 μm after the hardening.

(4-3) Formation of Low Refractive Index Layer “Coating-Hardening System C”

The procedure of “coating-hardening system A” was followed but carrying out predrying at 120° C. for 150 seconds followed by drying at 140° C. for 8 minutes and controlling the membrane thickness to 300 nm.

(4-4) Formation of Low Refractive Index Layer “Coating-Hardening System D”

The triacetyl cellulose film having the hard coat layer thus formed thereon was unwound again. Then, the coating solution for low refractive index layer as described above was applied by the die coating method. After drying at 120° C. for 150 seconds, the coating layer was further dried at 140° C. for 8 minutes and then irradiated, under nitrogen-purge, with ultraviolet light by using a 240 W/cm air-cool metal halide lamp (manufactured by EYEGRAPHICS Co., Ltd.) at an illuminance of 400 mW/cm² and an irradiation dose of 900 mJ/cm². Thus a low refractive index layer of 100 nm in thickness was formed and wound.

(4-5) Formation of Low Refractive Index Layer “Coating-Hardening System E”

The procedure of “coating-hardening system A” was followed but carrying out predrying at 120° C. for 150 seconds followed by drying at 140° C. for 8 minutes.

(Preparation of Antireflective Film Sample)

As Table 1 shows, antirefledtive film samples were prepared by the above methods.

TABLE 1

| | | Ratio of | | | | | |
|---|---|---|---|---|---|---|---|
| | | hollow silica | | | | | |
| | Low | size/ | | High | Medium | | |
| | refractive | large-sized | | refractive | refractive | Hard | |
| Sample | index | hollow | Coating | index | index | coat | |
| No. | layer | silica size | system | layer | layer | layer | Note |
| 101 | A | — | A | — | — | A | Comp. |
| 102 | B | — | A | — | — | A | Comp. |
| 103 | C | 2.7 | A | — | — | A | Comp. |
| 104 | D | 0.9 | A | — | — | A | Invention |
| 105 | E | 0.9 | A | — | — | A | Invention |
| 106 | F | 0.9 | A | — | — | A | Invention |
| 107 | I | 0.9 | C | A | A | B | Invention |
| 108 | D | 0.9 | B | — | — | A | Invention |
| 109 | G | 0.3 | A | — | — | A | Invention |
| 110 | H | 0.8 | A | — | — | A | Invention |

(Saponification of Antireflective Film)

After forming the film, the above samples were subjected to the following treatment.

A 1.5 mol/l aqueous solution of sodium hydroxide was prepared and maintained at 55° C. A 0.01 mol/l dilute aqueous solution of sulfuric acid was prepared and maintained at 35° C. Each antireflective film prepared was dipped in the aqueous sodium hydroxide solution for 2 minutes and then dipped in water to thereby sufficiently wash away the aqueous sodium hydroxide solution. Subsequently, it was dipped in the above dilute aqueous sulfuric acid solution for 1 minute and then dipped in water to thereby sufficiently wash away the dilute aqueous sulfuric acid solution. Finally, the sample was sufficiently dried at 120° C.

(Evaluation of Antireflective Film)

After the completion of the saponification treatment as described above, the obtained film samples were evaluated in the following items. To evaluate the face figure, a coated area 10 m² from the coating part was observed with the naked eye to indicate the failure level.

(1) Average Reflectance

The spectral reflectance at an incidence angle 5° was measured with the use of a spectrophotometer (manufactured by JASORGANOSILANE COMPOUNDO) in a wavelength range of 380 to 780 nm. The results are expressed in the average reflectance at 450 to 650 nm. Samples having a reflectance of at most 1.7 are good as causing little image reflection thereon. Those having a reflectance of at most 1.7 are on a grade “A”; and those having a reflectance of higher than 1.7 are on a grade “B”.

(2) Steel Wool (SW) Scratch Resistance Evaluation

By using a rubbing tester, a rubbing test was carried out under the following conditions.

Conditioning conditions: 25° C., 60% RH.

Rubbing material: Steel wool “Grade No. 000” (manufactured by NIHON STEEL WOOL K. K.) was wound around the edge (1 cm×1 cm) of a tester being in contact with a sample and fixed with a band.

Rubbing distance (one way): 13 cm. Rubbing speed: 13 cm/sec. Load: 500 g/cm². Edge contact area: 1 cm×1 cm. Rubbing frequency: 10 to-and-fro motions. After the completion of the rubbing, the back face of the sample was painted with a black oily ink and observed with the naked eye under reflected light. Then scratch marks in the rubbed part were evaluated in accordance with the following criteria.

A: No visible mark even in very careful observation.

B: Slight visible marks in very careful observation.

B/C: Slight visible marks in observation.

C: Moderate visible marks.

D/E to E: Marks found at first sight.

(3) Eraser-Abrasion Resistance

The antireflective film was fixed on a glass face with a pressure-sensitive adhesive. Then an eraser (MONO® manufactured by TOMBOW) cut into a disc shape (8 mm in diameter, 4 mm in thickness) as perpendicularly pressed, as the head of a rubbing tester, against the antireflective film face under a load of 500 g/cm². After reciprocally rubbing 20 times at a stroke length of 3.5 cm, a rubbing speed of 1.8 cm/s, the eraser sticking to the film was removed and the abrasion level of the sample was examined with the naked eye. After repeating the above test thrice, the scratch level of the surface was evaluated in the following four grades.

A: Scarcely any mark visible.

B: Slight marks visible.

C: Obvious marks visible.

D: Marks visible all over the surface.

(4) Felt Pen Wiping Off

The antireflective film was fixed on a glass face with a pressure sensitive adhesive and three circles (diameter 5 mm) were drawn with the pen point (fine) of a black felt pen “Mckee Gokuboso®, manufactured by ZEBRA Co.) at 25° C. and 60RH %. Five second thereafter, the circles were reciprocally wiped off 20 times with BEMCOT® (manufactured by ASAHI KASEI Co.) folded in ten under such a load as putting a dent on the BEMCOT sheets. The drawing and wiping were repeated under the above-described conditions until the ink trace became indelible and the wiping number was determined. This test was repeated four times and the average score was indicated in the following four grades.

TABLE 2

| | Reflec- | | SW | Eraser | Felt pen | | |
|---|---|---|---|---|---|---|---|
| Sample | tance | | rubbing | abrasion | wiping | Face | |
| No. | (%) | | resistance | resistance | off | figure | Note |
| 101 | B | 1.9 | D | A | A | B | Comp. |
| 102 | A | 1.2 | E | C | B | B | Comp. |
| 103 | A | 1.2 | E | C | A | B | Comp. |
| 104 | A | 1.2 | B | A | A | B | Invention |
| 105 | A | 1.2 | B | A | A | B | Invention |
| 106 | A | 1.2 | D | A | A | B | Invention |
| 107 | A | 0.4 | B | A | A | B | Invention |
| 108 | A | 1.2 | B | A | A | A | Invention |
| 109 | A | 1.2 | B | B | B | B | Invention |
| 110 | A | 1.2 | B | A | A | B | Invention |

A: Wiped off 10 times or more.
B: Wiped off two to 10 times.
C: Wiped off once.
D: Indelible.

The results given in Table 2 indicate the following facts.

A comparison of the samples 101 to 103 with the samples 104 to 110 indicates that the antireflective films according to the invention have low reflectances but obviously improved scratch resistances against rubbing with the steel wool (SW) or the eraser. Samples 104E and 104D were produced in the same manner as in the sample 104, except that the coating condition for the low refractive index layer in 104E was varied from the “coating-hardening system A” to the “coating-hardening system E” and that in 104D was to the “coating-hardening system D”, and these were evaluated in the same manner as herein. As a result, it was understood that the sample 104E was improved more than the sample 104 in point of its SW rubbing resistance and eraser abrasion resistance, and the sample 104E was more than the sample 104 in point of not only its SW rubbing resistance and eraser abrasion resistance but also its face figure.

### Example 2

The film samples 104 and 106 according to the invention were bonded to a polarizing plate to construct a polarizing plate equipped with the antireflective films. A liquid crystal display unit, which was constructed by using this polarizing plate and providing the antireflective film layer as the outermost layer, suffered from little reflection of outside light and had excellent visibility. It was particularly excellent in resistance to dust and debris, i.e., the most important factor in practical use.

### Example 3

A triacetyl cellulose film (80 μm in thickness, TAC-TDU80U manufactured by FUJI PHOTOFILM Co., Ltd.), which was dipped in a 1.5 mol/l aqueous solution of NaOH at 55° C. for 2 minutes and neutralized and washed with water, was bonded to both faces of a polarizing film which was produced by allowing a triacetyl cellulose film coated by the samples 104 and 106 according to the invention in EXAMPLE 1 to adsorb iodine and then stretching, and protected to give a polarizing plate. The polarizing plate in the viewing side of a liquid crystal display unit (having D-BEF manufactured by SUMITOMO 3M, i.e., a polarizing separation film provided with a polarizing selection layer between a backlight and a liquid crystal cell) of a laptop computer equipped with a transmission type TN liquid crystal display unit was replaced by the polarizing plate constructed above in such a manner that the antireflective film served as the outermost face. As a result, a display unit suffered from little reflection of outside light and had high display qualities and excellent in resistance to dust and debris could be obtained.

### Example 4

As a protective film in the liquid crystal cell side of a polarizing plate in the visible side of transmission TN mode liquid crystal cells, which had the antireflective film samples 104 to 106 according to the invention bonded thereto, and as a protective film in the liquid crystal cell side of the polarizing plate in the backlight side, use was made of a viewing angle-enlarging film (WIDE VIEW FILM SA-12B, manufactured by FUJI PHOTOFILM CO., LTD.) in which the disc face of a discotic structural unit inclined to the transparent support face and which had an optically compensatory layer with an angle between the disc face of a discotic structural unit and the transparent support face changing in the depth direction of the optically compensatory layer. As a result, a liquid crystal display unit showing a high contrast in a bright room and having very broad viewing angle from side to side and up and down, a highly favorable visibility and excellent image qualities could be obtained.

### Example 5

The antireflective film sample 106 according to the invention constructed in EXAMPLE 1 was bonded to the glass surface of an organic EL display unit with the use of a pressure sensitive adhesive. As a result, a display unit showing regulated reflection on the glass surface and high visibility and being sufficiently resistant to dust and debris could be obtained.

### Example 6

Using the antireflective film sample 106 according to the invention constructed in EXAMPLE 1, a polarizing plate having the antireflective film in one side was constructed. A λ/4 sheet was bonded to the face of the polarizing plate opposite to the antireflective film. Then the obtained polarizing plate was bonded to the surface glass plate of an organic EL display unit so that the antireflective film layer served as the outermost layer. As a result, a display unit being highly resistant to dust and debris, showing regulated reflection on the surface and reflection from the inside of the surface glass, and providing a high visible indication could be obtained.

### Example 7

(Preparation of Coating Solution C for Hard Coat Layer)

10 parts by mass of cyclohexanone, 85 parts by mass of partially-caprolactone-modified polyfunctional acrylate (DPCA-20 manufactured by NIPPON KAYAKU), 10 parts by mass of KBM-5103 (silane coupling agent manufactured by SHIN-ETSU CHEMICAL) and 5 parts by mass of a photopolymerization initiator (IRGACURE 184 manufactured by CIBA SPECIALITY CHEMICALS) were added to 90 parts by mass of MEK, and stirred. The mixture was filtered through a polypropylene filter having a pore size of 0.4 μm to prepare a coating solution C for hard coat layer.

(Preparation of Coating Solution D for Hard Coat Layer)

50 g of a mixture of pentaerythritol triacrylate and pentaerythritol tetraacrylate (PET-30 manufactured by NIPPON KAYAKU) was diluted with 38.5 g of toluene. Further, 2 g of a polymerization initiator (IRGACURE 184 manufactured by CIBA SPECIALITY CHEMICALS) was added thereto, mixed and stirred. The solution was applied onto a substrate and hardened thereon, and the coating film thus formed had a refractive index of 1.51.

1.7 g of a 30% dispersion in toluene of crosslinked polystyrene particles dispersed by the use of a polytron disperser at 10000 rpm for 20 minutes and having an average particle diameter of 3.5 μm (refractive index 1.61, SX-350 manufactured by SOKEN KAGAKU), and 13.3 g of a 30% dispersion in toluene of crosslinked acryl-styrene particles having an average particle diameter of 3.5 μm (refractive index 1.55, manufactured by SOKEN KAGAKU) were added to the solution, and finally, 0.75 g of a fluorine-containing surface improver (FP-107) and 10 g of a silane-coupling agent (KBM-5103 manufactured by SHIN-ETU KAGAKU KOGYO) were added thereto to complete a coating solution.

The above-mentioned mixture was filtered through a polypropylene filter having a pore size of 30 μm to prepare a coating solution A for light-scattering layer.

(Preparation of Coating Solution J for Low Refractive Index Layer)

6.20 g of a thermo-crosslinking fluorine-containing polymer (fluorine-containing silicone-containing thermosetting polymer described in Example 1 in JP-A 11-189621), 1.60 g of a hardening (curing) agent (CYMEL 303, trade name, manufactured by Nippon Cytec Industries), 0.16 g of a hardening (curing) catalyst (CATALYST 4050, trade name, manufactured by Nippon Cytec Industries), 13.0 g of silica sol (a type of silica MEK-ST having an average particle diameter of 45 nm and a solid concentration of 30%, manufactured by NISSAN CHEMICAL), 6.0 g of sol (a), 170 g of methyl ethyl ketone and 6.0 g of cyclohexanone were mixed and stirred, and filtered through a polypropylene filter having a pore size of 1 μm to prepare a coating solution J for low refractive index layer.

(Preparation of Coating Solution K for Low Refractive Index Layer)

6.20 g of a thermo-crosslinking fluorine-containing polymer (fluorine-containing silicone-containing thermosetting polymer described in Example 1 in JP-A 11-189621), 1.60 g of a hardening agent (CYMEL 303, trade name, manufactured by Nippon Cytec Industries), 0.16 g of a hardening catalyst (CATALYST 4050, trade name, manufactured by Nippon Cytec Industries), 16.6 g of hollow silica A (20%), 1.95 g of silica sol (a type of silica MEK-ST having an average particle diameter of 45 nm and a solid concentration of 30%, manufactured by NISSAN CHEMICAL), 6.0 g of sol (a), 170 g of methyl ethyl ketone and 6.0 g of cyclohexanone were mixed and stirred, and filtered through a polypropylene filter having a pore size of 1 μm to prepare a coating solution K for low refractive index layer.

(Preparation of Coating Solution L for Low Refractive Index Layer)

6.20 g of a thermo-crosslinking fluorine-containing polymer (fluorine-containing silicone-containing thermosetting polymer described in Example 1 in JP-A 11-189621), 1.60 g of a hardening agent (CYMEL 303, trade name, manufactured by Nippon Cytec Industries), 0.16 g of a hardening catalyst (CATALYST 4050, trade name, manufactured by Nippon Cytec Industries), 16.6 g of hollow silica D (20%), 1.95 g of silica sol (a type of silica MEK-ST having an average particle diameter of 45 nm and a solid concentration of 30%, manufactured by NISSAN CHEMICAL), 6.0 g of sol (a), 170 g of methyl ethyl ketone and 6.0 g of cyclohexanone were mixed and stirred, and filtered through a polypropylene filter having a pore size of 1 μm to prepare a coating solution L for low refractive index layer.

(Preparation of Coating Solution M for Low Refractive Index Layer)

6.20 g of a thermo-crosslinking fluorine-containing polymer (fluorine-containing silicone-containing thermosetting polymer described in Example 1 in JP-A 11-189621), 1.60 g of a hardening agent (CYMEL 303, trade name, manufactured by Nippon Cytec Industries), 0.16 g of a hardening catalyst (CATALYST 4050, trade name, manufactured by Nippon Cytec Industries), 16.6 g of hollow silica A (20%), 2.9 g of hollow silica C (20%), 6.0 g of sol (a), 170 g of methyl ethyl ketone and 6.0 g of cyclohexanone were mixed and stirred, and filtered through a polypropylene filter having a pore size of 1 μm to prepare a coating solution M for low refractive index layer.

(Preparation of Coating Solution N for Low Refractive Index Layer)

6.20 g of a thermo-crosslinking fluorine-containing polymer (fluorine-containing silicone-containing thermosetting polymer described in Example 1 in JP-A 11-189621), 1.60 g of a hardening agent (CYMEL 303, trade name, manufactured by Nippon Cytec Industries), 0.16 g of a hardening catalyst (CATALYST 4050, trade name, manufactured by Nippon Cytec Industries), 16.6 g of hollow silica D (20%), 2.9 g of hollow silica E (20%), 6.0 g of sol (a), 170 g of methyl ethyl ketone and 6.0 g of cyclohexanone were mixed and stirred, and filtered through a polypropylene filter having a pore size of 1 μm to prepare a coating solution N for low refractive index layer.

(Preparation of Coating Solution P for Low Refractive Index Layer)

6.20 g of a thermo-crosslinking fluorine-containing polymer (fluorine-containing silicone-containing thermosetting polymer described in Example 1 in JP-A 11-189621), 1.60 g of a hardening agent (CYMEL 303, trade name, manufactured by Nippon Cytec Industries), 0.16 g of a hardening catalyst (CATALYST 4050, trade name, manufactured by Nippon Cytec Industries), 19.5 g of hollow silica A (20%), 6.0 g of sol (a), 170 g of methyl ethyl ketone and 6.0 g of cyclohexanone were mixed and stirred, and filtered through a polypropylene filter having a pore size of 1 μm to prepare a coating solution P for low refractive index layer.

(Preparation of Coating Solution Q for Low Refractive Index Layer)

4.7 g of perfluoro-olefin copolymer (1), 19.5 g of hollow silica A (20.0%), 4.5 g of hollow silica C (20%), 0.14 g of reactive silicone X22-164 (trade name, manufactured by SHIN-ETSU CHEMICAL), 1.27 g of sol (a), 0.24 g of a photopolymerization initiator (IRGACURE 907, trade name, manufactured by CIBA SPECIALITY CHEMICALS), 15.6 g of cyclohexanone and 122 g of MEK were mixed and stirred, and filtered through a polypropylene filter having a pore size of 1 μm to prepare a coating solution Q for low refractive index layer.

(Preparation of Coating Solution R for Low Refractive Index Layer)

2.3 g of a mixture of dipentaerythritol pentaacrylate and dipentaerythritol hexaacrylate (DPHA, manufactured by NIPPON KAYAKU), 25.5 g of hollow silica D (20%), 3.0 g of silica sol (a type of silica MEK-ST having an average particle diameter of 45 nm and a solid concentration of 30%, manufactured by NISSAN CHEMICAL), 2.0 g of sol (a), 0.15 g of reactive silicone X-22-164B (trade name, manufactured by SHIN-ETSU CHEMICAL), 0.50 g of a fluorine-containing compound F3035 (trade name, manufactured by NIPPON YUSHI, having a solid concentration of 30%), 0.20 g of a photopolymerization initiator (IRGACURE 907, trade name, manufactured by CIBA SPECIALITY CHEMICALS), 90.0 g of methyl ethyl ketone and 3.0 g of cyclohexanone were mixed and stirred, and filtered through a polypropylene filter having a pore size of 5 μm to prepare a coating solution R for low refractive index layer.

(Preparation of Coating Solution S for Low Refractive Index Layer)

2.3 g of a mixture of dipentaerythritol pentaacrylate and dipentaerythritol hexaacrylate (DPHA, manufactured by NIPPON KAYAKU), 20.0 g of silica sol (a type of silica MEK-ST having an average particle diameter of 45 nm and a solid concentration of 30%, manufactured by NISSAN CHEMICAL), 2.0 g of sol (a), 0.15 g of reactive silicone X-22-164B (trade name, manufactured by SHIN-ETSU CHEMICAL), 0.50 g of a fluorine-containing compound F3035 (trade name, manufactured by NIPPON YUSHI, having a solid concentration of 30%), 0.20 g of a photopolymerization initiator (IRGACURE 907, trade name, manufactured by CIBA SPECIALITY CHEMICALS), 90.0 g of methyl ethyl ketone and 3.0 g of cyclohexanone were mixed and stirred, and filtered through a polypropylene filter having a pore size of 5 μm to prepare a coating solution R for low refractive index layer.

The dispersions used herein are mentioned below.

Hollow Silica D:

Hollow silica sol (prepared according to Preparation Example 4 in JP-A 2002-79616—this has an average particle diameter of about 40 nm and a shell thickness of about 7 nm, and the refractive index of silica particles therein is 1.31) was surface-treated with trimethylmethoxysilane in an amount of 10% by mass of the silica solid content of the sol, and the solvent was substituted with MEK. Having a controlled solid concentration of 20%, this is hollow silica D.

Hollow Silica E:

Hollow silica sol (prepared according to Preparation Example 4 in JP-A 2002-79616 but changing the condition therein—this has an average particle diameter of about 60 nm and a shell thickness of about 10.5 nm, and the refractive index of silica particles therein is 1.31) was surface-treated with trimethylmethoxysilane in an amount of 10% by mass of the silica solid content of the sol, and the solvent was substituted with MEK. Having a controlled solid concentration of 20%, this is hollow silica E.

Formation of Hard Coat Layer C

As a substrate, a triacetyl cellulose film (TD80U, manufactured by FUJI PHOTOFILM) was unwound in a rolled state. Then the coating solution C for hard coat layer as described above was directly applied by using a microgravure roll (diameter: 50 mm) having a gravure pattern of a line density of 135 lines/in. and a depth of 60 μM and a doctor blade at a conveying speed of 10 m/min. After drying at 60° C. for 150 seconds, the coating layer was hardened by irradiating under nitrogen-purge with ultraviolet light by using a 160 W/cm air-cool metal halide lamp (manufactured by EYEGRAPHICS) at an illuminance of 400 mW/cm² and an irradiation dose of 120 mJ/cm². Thus a hard coat layer was formed and wound. The gravure roll rotational speed was controlled so as to give a hard coat layer thickness of 4.5 μm after the hardening. Thus formed, the hard coat layer C had a surface roughness of Ra=0.01 μm and Rz=0.01 μm.

Formation of Hard Coat Layer D

As a substrate, a triacetyl cellulose film (TD80U, manufactured by FUJI PHOTOFILM) was unwound in a rolled state. Then the coating solution D for hard coat layer as described above was directly applied by using a microgravure roll (diameter: 50 mm) having a gravure pattern of a line density of 135 lines/in. and a depth of 60 μm and a doctor blade at a conveying speed of 10 m/min. After drying at 60° C. for 150 seconds, the coating layer was hardened by irradiating under nitrogen-purge with ultraviolet light by using a 160 W/cm air-cool metal halide lamp (manufactured by EYEGRAPHICS) at an illuminance of 400 mW/cm² and an irradiation dose of 120 mJ/cm². Thus a hard coat layer was formed and wound. The gravure roll rotational speed was controlled so as to give a hard coat layer thickness of 5.5 μm after the hardening. Thus formed, the hard coat layer D had a surface roughness of Ra=0.03 μm, RMS=0.04 and Rz=0.27 μm. (Ra (center line average height), RMS (root-mean-square surface roughness), and Rz (n-points average height) were determined by the use of a scanning probe microscope system, SPI3800 (manufactured by Seiko Instruments).)

Formation of Low Refractive Index Layer “Coating-Hardening System F”

The triacetyl cellulose film having the hard coat layer thus formed thereon was unwound again. Then, the coating solution for low refractive index layer as described above was applied by using a microgravure roll (diameter: 50 mm) having a gravure pattern of a line density of 180 lines/in. and a depth of 40 μm and a doctor blade at a conveying speed of 25 m/min. After drying at 120° C. for 100 seconds, the coating layer was further hardened at 110° C. for 10 minutes. Next, under nitrogen-purge with keeping the oxygen concentration around it within a range of from 0.01 to 0.10%, this was irradiated with ultraviolet light by using a 240 W/cm air-cool metal halide lamp (manufactured by EYEGRAPHICS Co., Ltd.) at an illuminance of 400 mW/cm² and an irradiation dose of 240 mj/cm². Thus a low refractive index layer was formed and wound, while controlling the gravure roll rotational speed so as to give a layer thickness of 95 nm.

Formation of Low Refractive Index Layer “Coating-Hardening System G”

The triacetyl cellulose film having the hard coat layer thus formed thereon was unwound again. Then, the coating solution for low refractive index layer as described above was applied by using a microgravure roll (diameter: 50 mm) having a gravure pattern of a line density of 180 lines/in. and a depth of 40 μm and a doctor blade at a conveying speed of 25 m/min. After predrying at 90° C. for 50 seconds, the coating layer was irradiated with ultraviolet light, under nitrogen-purge with keeping the oxygen concentration around it within a range of from 0.01 to 0.10%, by using a 240 W/cm air-cool metal halide lamp (manufactured by EYEGRAPHICS Co., Ltd.) at an illuminance of 400 mW/cm² and an irradiation dose of 240 mJ/cm². Thus a low refractive index layer was formed and wound, while controlling the gravure roll rotational speed so as to give a layer thickness of 95 nm.

(Preparation of Antireflective Film Samples)

Antireflective film samples were prepared by combining the hard coat layer and the low refractive index layer thereof as in Table 3. These were saponified and evaluated in the same manner as in Example 1. The test results are given in Table 3.

TABLE 3

| | | Low | Ratio of hollow | | | | | | |
|---|---|---|---|---|---|---|---|---|---|
| | Hard | refractive | silica size/ | Coating- | | | Eraser | Felt pen | |
| Sample | coat | index layer | large-size | hardening | Reflectance | SW rubbing | abrasion | wiping | |
| No. | layer | solution | silica size | system | (%) | resistance | resistance | off | Note |
| 701 | C | J | — | F | 2.3 | A | A | A | Comp. |
| 702 | C | K | 0.89 | F | 1.4 | A | A | A | Invention |
| 703 | C | L | 0.89 | F | 1.3 | A | A | A | Invention |
| 704 | C | M | 0.40 | F | 1.2 | A | A | A | Invention |
| 705 | C | N | 0.67 | F | 1.1 | A | A | A | Invention |
| 706 | C | P | — | F | 1.3 | E | C | B | Comp. |
| 707 | C | Q | 0.67 | G | 1.2 | A | A | A | Invention |
| 708 | A | R | 0.89 | G | 1.5 | A | A | A | Invention |
| 709 | A | S | — | G | 2.5 | A | A | A | Comp. |

The results given in Table 3 indicate the following facts.

It is understood that the constitution which contains at least two different types of particles and contains particles having a larger average particle diameter than that of hollow silica in the low refractive index layer gives an antireflective film of low reflectivity and good abrasion resistance. It is also understood that the sample 708, in which an ordinary monomer was used for the binder but a fluorine-containing polymer was not used for the principal ingredient of the binder, gave an antireflective film of low reflectivity and good abrasion resistance.

### Example 8

Samples 801 to 809 were prepared in the same manner as in Example 7, except that the hard coat layer in Example 7 was changed to the hard coat layer D. These were evaluated in the same manner as in Example 7, which confirmed that the invention gives antireflective films of low reflectivity and good abrasion resistance.

### INDUSTRIAL APPLICABILITY

Since the hardening composition according to the invention has both of low refractive characteristics and a high mechanical strength, an antireflective film made of the hardening composition has a sufficient antireflective performance and scratch resistance. Moreover, it can be conveniently and economically produced. When used as a protective film of a polarizing plate, the antireflective film according to the invention can exert excellent antireflective properties and scratch resistance. The antireflective film and polarizing plate according to the invention are appropriately usable in image display units, in particular liquid crystal display units.

The entire disclosure of each and every foreign patent application from which the benefit of foreign priority has been claimed in the present application is incorporated herein by reference, as if fully set forth.

1. A hardening composition comprising:
a binder comprising at least one of a hardening monomer and a polymer;
hollow silica fine particles; and
inorganic fine particles,
wherein the inorganic fine particles has an average particle diameter larger than an average particle diameter of the hollow silica fine particles.

2. The hardening composition according to claim 1, which further comprises at least one of a hydrolysate of an organosilane represented by formula (A) and a partial condensation product of an organosilane represented by formula (A):
(R¹⁰)ₘSi(X)₄₋ₘ formula (A):
wherein R¹⁰ represents a substituted or unsubstituted alkyl group or a substituted or unsubstituted aryl group;
X represents a hydroxyl group or a hydrolyzable group; and
m is an integer of from 1 to 3.

3. The hardening composition according to claim 1,
wherein at least one of the inorganic fine particles and the hollow silica fine particles is surface-treated with an organosilane compound represented by formula (A).

4. The antireflective film comprising an optically functional layer formed from a hardening composition according to claim 1.

5. The antireflective film according to claim 4,
wherein an average particle diameter of the inorganic fine particles having an average particle diameter larger than an average particle diameter of the hollow silica fine particles is not more than 120% based on an average layer thickness of the optically functional layer.

6. A method of producing an antireflective film according to claim 4, the method comprising:
forming an optically functional layer by applying a hardening composition by a die coating method.

7. A polarizing plate comprising an antireflective film according to claim 4.

8. An image display unit comprising an antireflective film according to claim 4.
